(19) United States
(12) Patent Application Publication
(10) Pub. No.: US 2026/0363925 A1
(43) Pub. Date: Nov. 19, 2026

(54) Patient Transport System Including A Collapsible Head Brace

(71) Applicant: Stryker Corporation, Portage, MI (US)

(72) Inventors: Sean Derrick, Kalamazoo, MI (US); Cory P. Herbst, Shelbyville, MI (US); Blake Macias, Ortonville, MI (US)

(73) Assignee: Stryker Corporation, Portage, MI (US)

(21) Appl. No.: 19/121,911

(22) PCT Filed: Oct. 18, 2023
(86) PCT No.: PCT/US2023/035368

§ 371 Date: Apr. 17, 2025

Related U.S. Application Data
(60) Provisional application No. 63/417,108, filed on Oct. 18, 2022.
(60) Provisional application No. 63/436,166, filed on Dec. 30, 2022.

(51) Int. Cl. A61G 5/06; A61G 5/04

(52) U.S. Cl. CPC A61G 5/061; A61G 5/041; A61G 5/066

(57) ABSTRACT

A patient transport system for transporting a patient along stairs. The patient transport system includes a support structure including a rear support assembly. The patient transport system also includes a handle assembly. The patient transport system further includes a head brace. The head brace includes a flexible panel extending between a lower region and an upper region, a lower coupler operatively attached to the lower region and releasably attached to the rear support assembly, and an upper coupler operatively attached to the upper region and releasably attached to the handle assembly. Movement of the handle assembly to the extended position places tension in the flexible panel to define a head support surface for the patient.

### CROSS-REFERENCE TO RELATED APPLICATIONS

The subject patent application claims priority to and all the benefits of U.S. Provisional Patent Application No. 63/436,166 filed on Dec. 30, 2022, and to U.S. Provisional Patent Application No. 63/417,108 filed on Oct. 18, 2022, the disclosures of each of which are hereby incorporated by reference in their entirety.

### BACKGROUND

In various environments, persons with limited mobility may have difficulty traversing stairs without assistance. In certain emergency situations, traversing stairs may be the only viable option for exiting a building. Here, in order for a caregiver to transport a patient along stairs in a safe and controlled manner, a stair chair or evacuation chair may be utilized to facilitate safe stair traversal. Stair chairs are adapted to transport seated patients either up or down flights of stairs, with two caregivers typically supporting, stabilizing, or otherwise carrying the stair chair with the patient supported thereon.

While patient transport systems have generally performed well for their intended purpose, there remains a need in the art to provide a patient transport system with improved usability under a number of different operating conditions.

### SUMMARY

The present disclosure includes a patient transport system. The patient transport system includes a support structure including rear support assembly, a seat section and a back section coupled to the support structure and defining a support surface for supporting a patient, and a track assembly extending from the support structure and having a belt for traversing stairs. The patient transport system also includes a handle assembly operatively attached to the rear support assembly and configured for movement between a collapsed position and an extended position, a motor coupled to the track assembly to selectively generate torque to drive the belt, and a user interface including an activation input control disposed on the handle assembly and arranged for engagement by a user for operating the motor to drive the belt. The patient transport system further includes a head brace. The head brace includes a flexible panel extending between a lower region and an upper region, a lower coupler operatively attached to the lower region and releasably attached to the rear support assembly, and an upper coupler operatively attached to the upper region and releasably attached to the handle assembly. Movement of the handle assembly to the extended position places tension in the flexible panel to define a head support surface for the patient.

### BRIEF DESCRIPTION OF THE DRAWINGS

Other advantages of the present invention will be readily appreciated as the same becomes better understood by reference to the following detailed description when considered in connection with the accompanying drawings.

FIG. 1 is another front perspective view of the patient transport system of FIG. 1, shown arranged in a stair configuration for supporting a patient for transport along stairs, and shown with a track assembly disposed in a deployed position, and with a handle assembly disposed in an extended position.

FIG. 2 is a front perspective view of a patient transport system according to the present disclosure, shown arranged in a chair configuration for supporting a patient for transport along a floor surface, and shown having a track assembly disposed in a retracted position, and a handle assembly disposed in a collapsed position.

FIG. 3 is a rear perspective view of the patient transport system of FIGS. 1-2, shown arranged in the stair configuration as depicted in FIG. 1, and shown having an extension lock mechanism, a folding lock mechanism, and a deployment lock mechanism.

FIG. 4 is a partial schematic view of a control system of the patient transport system of FIGS. 1-3, shown with a controller disposed in communication with a battery, a user interface, and a drive system.

FIG. 5 is a right-side plan view of the patient transport system of FIGS. 1-4, shown arranged in a stowed configuration maintained by the folding lock mechanism.

FIG. 6A is another right-side plan view of the patient transport system arranged in the chair configuration and with a handle assembly in a collapsed position.

FIG. 6B is another right-side plan view of the patient transport system arranged in the chair configuration and with the handle assembly in an intermediate position.

FIG. 6C is another right-side plan view of the patient transport system arranged in the chair configuration and with the handle assembly in an extended position

FIG. 7A is a partial rear perspective view of the patient transport system of FIGS. 1-6B, shown arranged in the chair configuration as depicted in FIG. 1, with the deployment lock mechanism shown retaining the track assembly in the retracted position.

FIG. 7B is another partial rear perspective view of the patient transport system of FIG. 7A, shown arranged in the stair configuration as depicted in FIGS. 2-3, with the deployment lock mechanism shown retaining the track assembly in the deployed position.

FIG. 8 is a rear view of the back side of the patient transport system of FIG. 1 depicting the user interface.

FIG. 9A is a right-side plan view of the patient transport system of FIG. 1, shown supporting a patient in the chair configuration on a floor surface adjacent to stairs, and shown with a first caregiver engaging a pivoting handle assembly.

FIG. 9B is another right-side plan view of the patient transport system of FIG. 9A, shown with the first caregiver having engaged the deployment lock mechanism to move the track assembly out of the retracted position and a second caregiver engaging a front handle assembly in an extended position.

FIG. 9C is another right-side plan view of the patient transport system of FIG. 9B, shown having moved towards the stairs for descent while supported by the first and second caregivers.

FIG. 9D is another right-side plan view of the patient transport system of FIG. 9C, shown having moved initially down the stairs for descent to bring a belt of the track assembly into contact with the stairs while still supported by the first and second caregivers.

FIG. 9E is another right-side plan view of the patient transport system of FIG. 9D, shown with the belt of the track assembly in contact with the stairs while still supported by the first and second caregivers.

FIG. 9F is another right-side plan view of the patient transport system of FIG. 9D, shown with the belt of the track assembly in contact with the stairs while still supported by the first and second caregivers and with first.

FIG. 10A is a rear view of one example of the head brace.

FIG. 10B is a front view of the head brace of FIG. 10A.

FIG. 11 is a partial rear view of the patient transport system including the head brace of FIG. 10A coupled to the handle assembly and the rear support assembly.

FIG. 12A is a partial rear perspective view of the patient transport system including the head brace where a lower latch of the head brace is spaced from a lower catch disposed on the rear support assembly of the patient transport system.

FIG. 12B is a partial rear perspective view of the patient transport system including the head brace where a lower latch of the head brace is engaged with the lower catch disposed on the rear support assembly of the patient transport system.

FIG. 13A is a rear view of another example of the head brace.

FIG. 13B is a front view of the head brace of FIG. 13A.

FIG. 14 is a partial rear view of the patient transport system including the head brace of FIG. 13A coupled to the handle assembly and the rear support assembly.

FIG. 15 is a partial perspective view of the handle assembly of the patient transport system of FIG. 1, shown supporting hook assemblies.

FIG. 16 is a perspective view of another version of a head brace according to the present disclosure.

FIG. 17 is a partial rear view of the patient transport system including the head brace of FIG. 16 coupled to the rear support assembly and to the hook assemblies operatively attached to the handle assembly of FIG. 15.

FIG. 18A is a perspective view of one of the hook assemblies of FIGS. 15 and 17.

FIG. 18B is an exploded perspective view of the hook assembly of FIG. 18A, shown having a brace body, a collar body, and a clip.

FIG. 19 is a perspective view of the clip of the hook assembly of FIG. 18B.

FIG. 20A is a partial perspective view depicting a portion of the handle assembly of FIG. 15 spaced from the brace body and the collar body of the hook assembly of FIGS. 18A-18B to illustrate attachment of the hook assembly to the handle assembly.

FIG. 20B is another partial perspective view of the handle assembly and the hook assembly of FIG. 20A, shown with the brace body releasably engaging the collar body about a portion of the handle assembly.

FIG. 20C is another partial perspective view of the handle assembly and the hook assembly of FIG. 20B, shown with the clip retaining the collar body in engagement with the brace body.

FIG. 20D is another partial perceptive view of the handle assembly and the hook assembly of FIG. 20C, shown with the handle assembly depicted in phantom outline for illustrative purposes.

### DETAILED DESCRIPTION

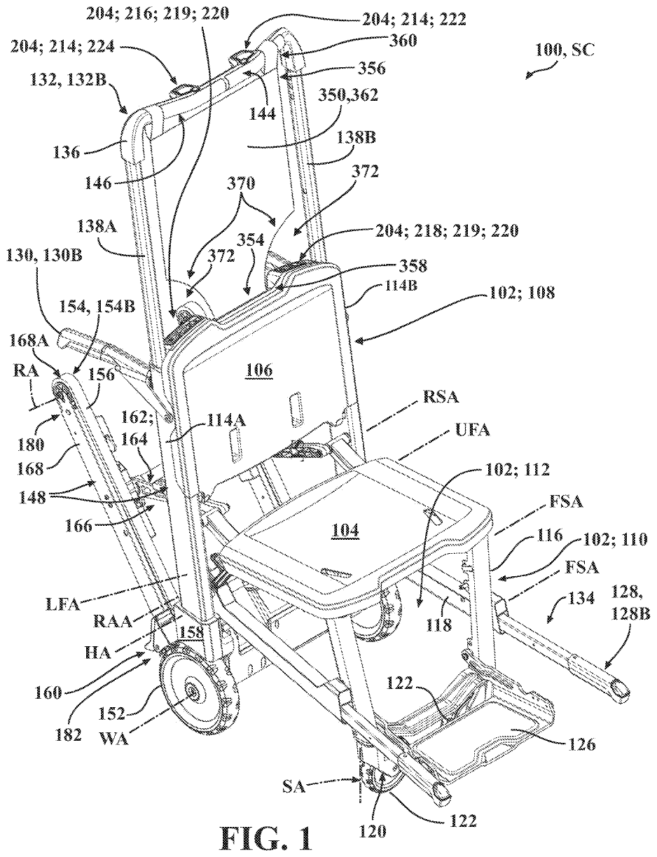

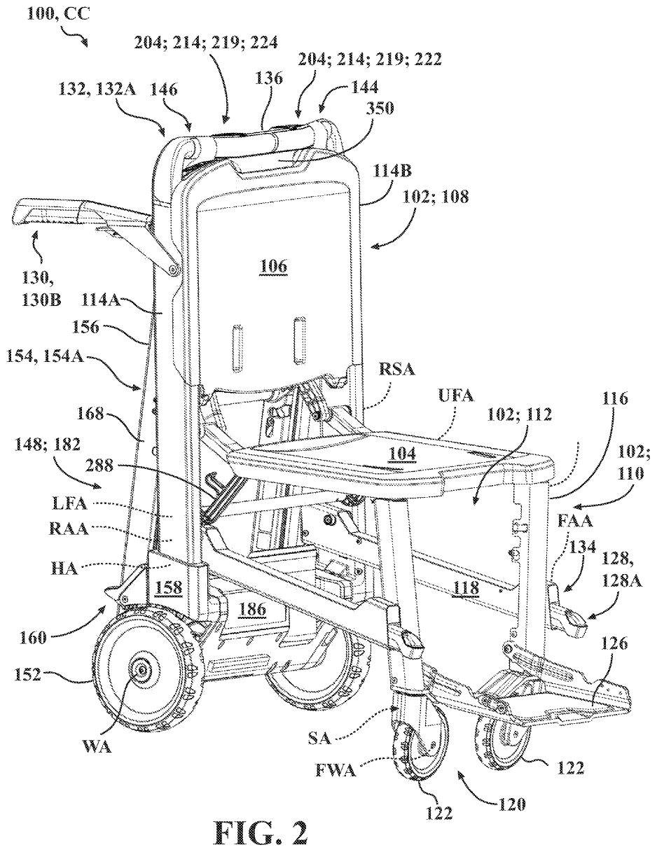

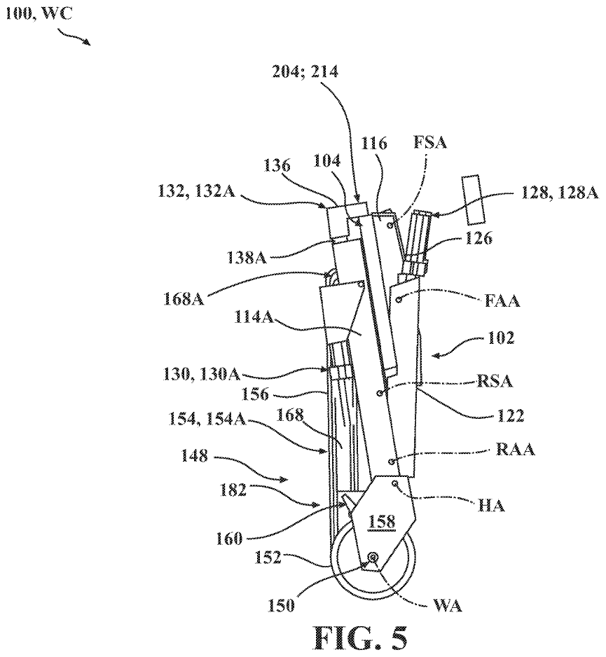

Referring now to the drawings, wherein like numerals indicate like parts throughout the several views, the present disclosure is generally directed toward a patient transport system 100 configured to allow one or more caregivers to transport a patient. To this end, the patient transport system 100 is realized as a “stair chair” which can be operated in a chair configuration CC (see FIG. 2) to transport the patient across ground or floor surfaces FS (e.g., pavement, hallways, and the like), as well as in a stair configuration SC (see FIG. 1) to transport the patient along stairs ST. As will be appreciated from the subsequent description below, the patient transport system 100 of the present disclosure is also configured to be operable in a stowed configuration WC (see FIG. 5) when not being utilized to transport patients (e.g., for storage in an ambulance).

As is best shown in FIG. 2, the patient transport system 100 comprises a support structure 102 to which a seat section 104 and a back section 106 are operatively attached. The seat section 104 and the back section 106 are each shaped and arranged to provide support to the patient during transport. The support structure 102 generally includes a rear support assembly 108, a front support assembly 110, and an intermediate support assembly 112. The back section 106 is coupled to the rear support assembly 108 for concurrent movement. To this end, the rear support assembly 108 comprises a first rear upright 114A arranged on a first side of the rear support assembly 108. The rear support assembly 108 may further comprise a second read upright 114B on a second side of the rear support assembly 108, opposite the first side. The rear uprights 114A, 114B may extend generally vertically and are secured to the back section 106 such as with fasteners (not shown in detail).

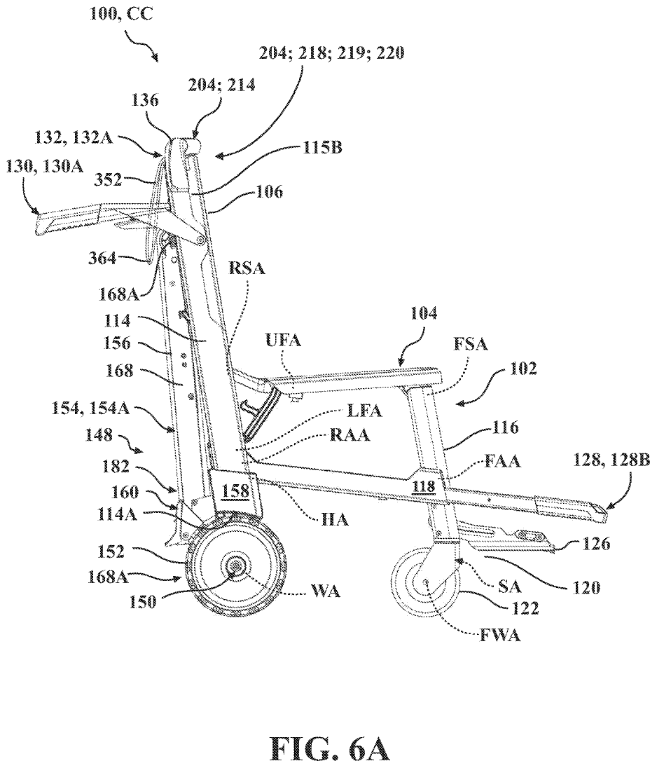

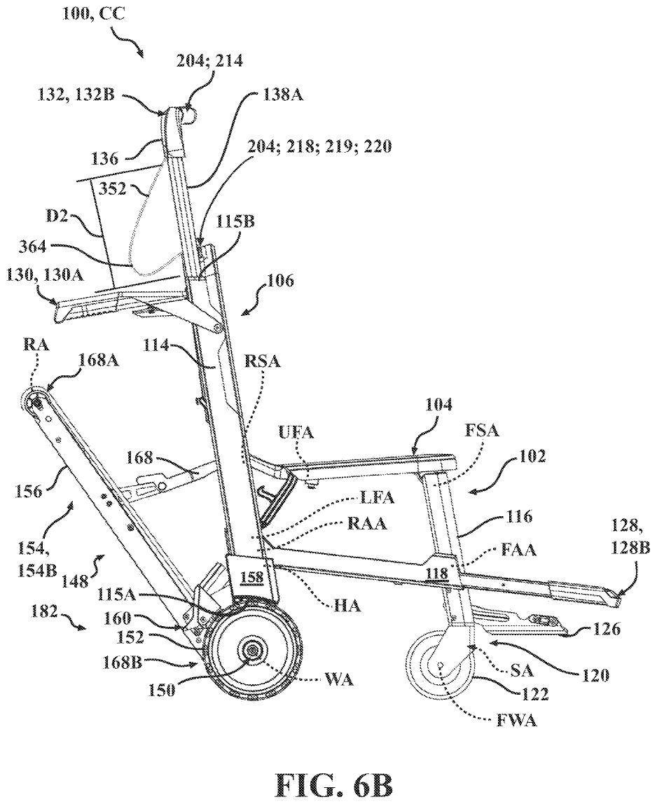

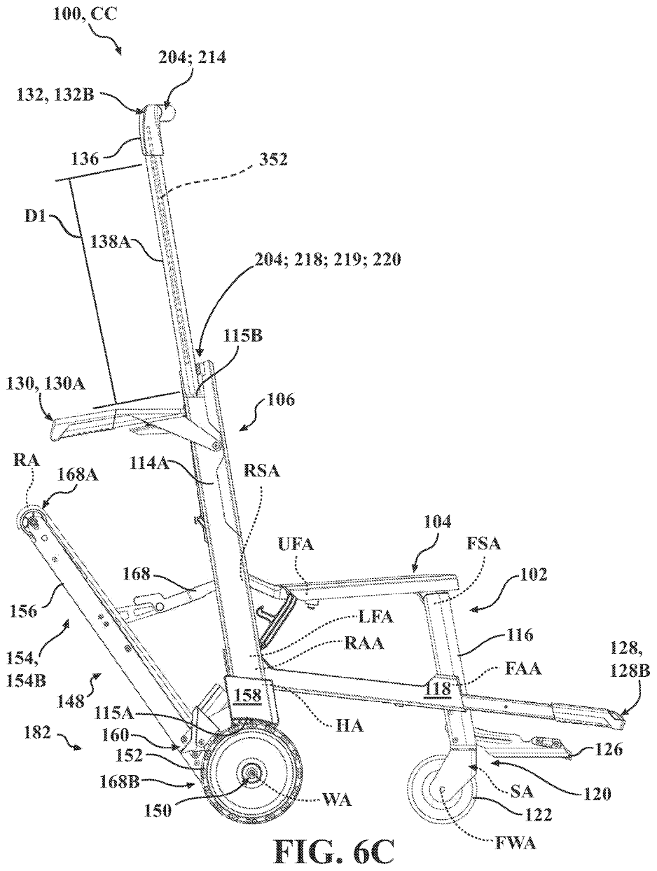

The intermediate support assembly 112 and the seat section 104 are each pivotably coupled to the rear support assembly 108. More specifically, the seat section 104 is arranged so as to pivot about a rear seat axis RSA which extends through the rear uprights 114A,114B (compare FIGS. 5-6A; pivoting about rear seat axis RSA not shown in detail), and the intermediate arms 118 of the intermediate support assembly 112 are arranged so as to pivot about a rear arm axis RAA which is spaced from the rear seat axis RSA and also extends through the rear uprights 114A, 114B (compare FIGS. 5-6A; pivoting about rear arm axis RAA not shown in detail). Furthermore, the intermediate support assembly 112 and the seat section 104 are also each pivotably coupled to the front support assembly 110. Here, the seat section 104 pivots about a front seat axis FSA which extends through the front struts 116 (compare FIGS. 5-6A; pivoting about front seat axis FSA not shown in detail), and the intermediate arms 118 pivot about a front arm axis FAA which is spaced from the front seat axis FSA and extends through the front struts 116 (compare FIGS. 5-6A; pivoting about front arm axis FAA not shown in detail). The intermediate support assembly 112 is disposed generally vertically below the seat section 104 such that the rear support assembly 108, the front support assembly 110, the intermediate support assembly 112, and the seat section 104 generally define a four-bar linkage which helps facilitate movement between the stowed configuration WC (see FIG. 5) and the chair configuration CC (see FIG. 6A). While the seat section 104 is generally configured to remain stationary relative to the support structure 102 when operating in the chair configuration CC or in the stair configuration CC according to the illustrated versions, it is contemplated that the seat section 104 could comprise multiple components which cooperate to facilitate “sliding” movement relative to the seat section 104 under certain operating conditions, such as to position the patient's center of gravity advantageously for transport. Other configurations are contemplated.

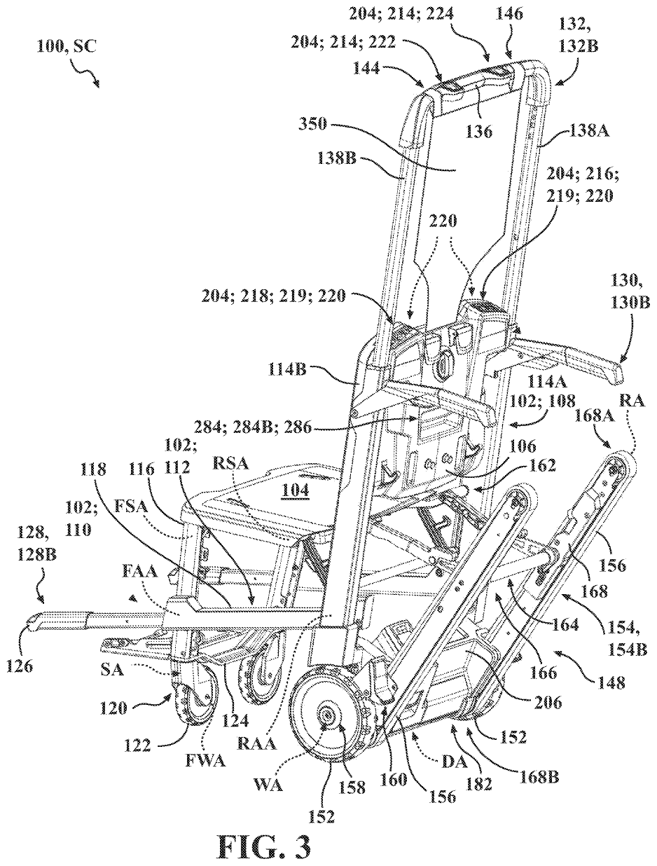

Referring now to FIGS. 1-3, the front support assembly 110 includes a pair of caster assemblies 120 which each comprise a front wheel 122 arranged to rotate about a respective front wheel axis FWA and to pivot about a respective swivel axis SA (compare FIGS. 5-6A; pivoting about swivel axis SA not shown in detail). The caster assemblies 120 are generally arranged on opposing lateral sides of the front support assembly 110 and are operatively attached to the front struts 116. A lateral brace 124 (see FIG. 3) extends laterally between the front struts 116 to, among other things, afford rigidity to the support structure 102. Here, a foot rest 126 is pivotably coupled to each of the front struts 116 adjacent to the caster assemblies 120 (pivoting not shown in detail) to provide support to the patient's feet during transport. For each of the pivotable connections disclosed herein, it will be appreciated that one or more fasteners, bushings, bearings, washers, spacers, and the like may be provided to facilitate smooth pivoting motion between various components.

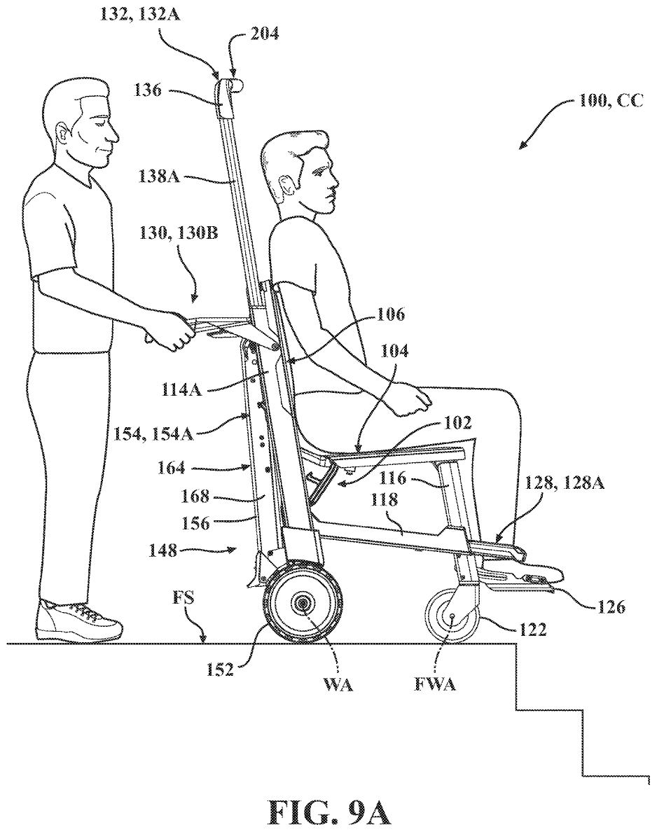

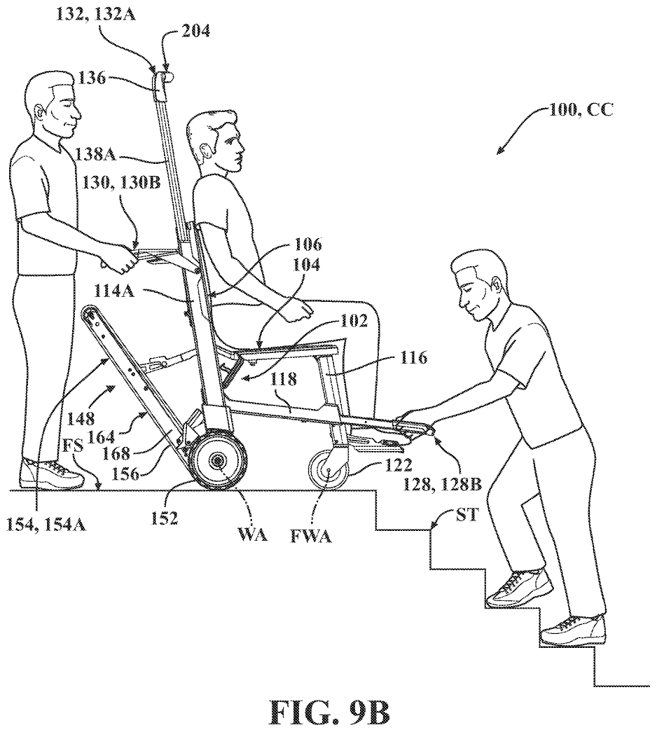

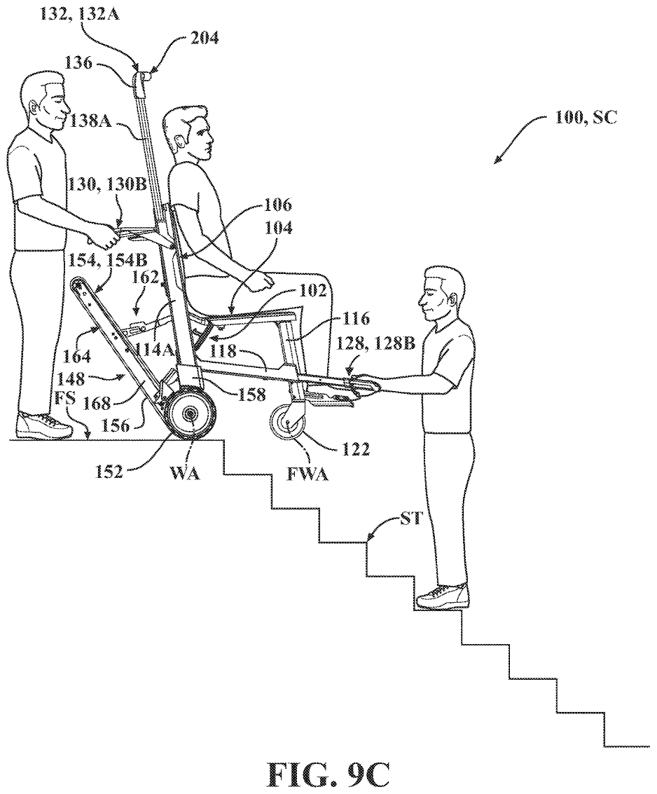

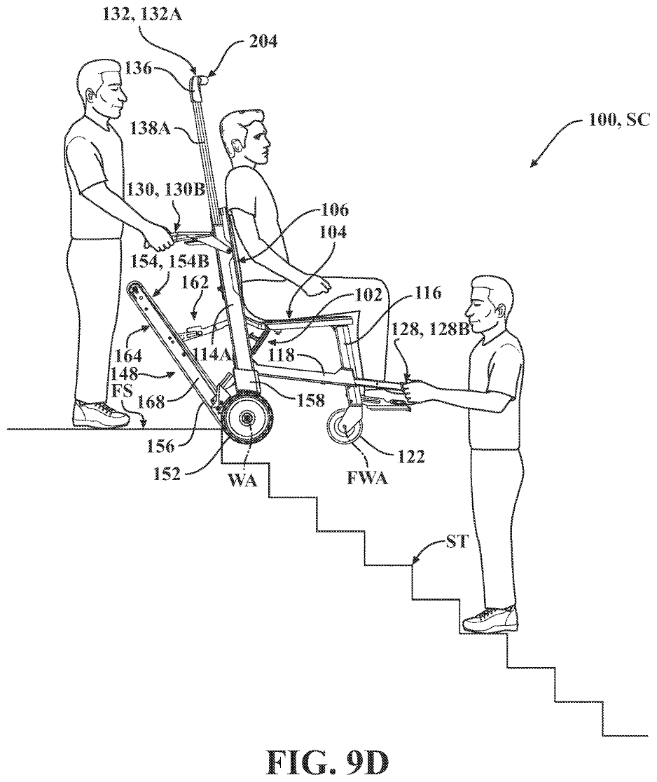

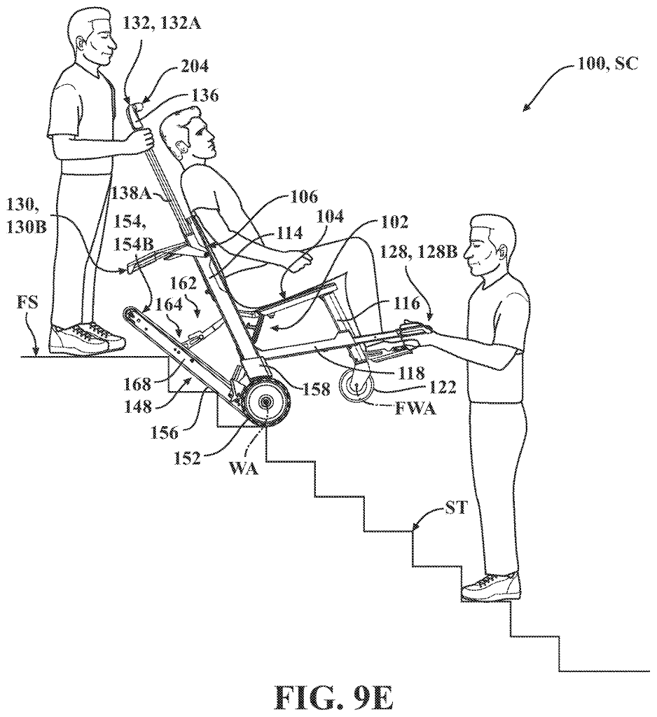

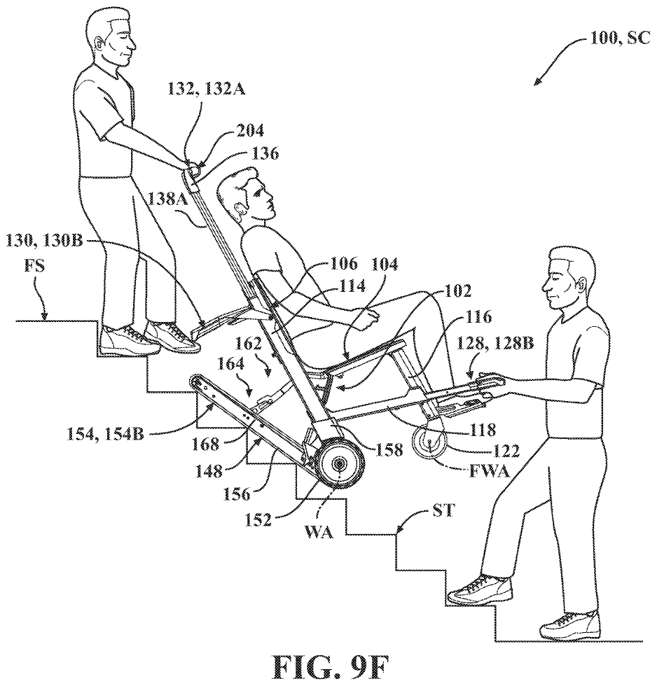

The representative versions of the patient transport system 100 illustrated throughout the drawings comprise different handles arranged for engagement by caregivers during patient transport. More specifically, the patient transport system 100 comprises front handle assemblies 128, pivoting handle assemblies 130, and an upper handle assembly 132 (hereinafter referred to as “handle assembly 132”), each of which will be described in greater detail below. The front handle assemblies 128 are supported within the respective intermediate arms 118 for movement between a collapsed position 128A (see FIG. 9A) and an extended position 128B (see FIG. 9B). To this end, the front handle assemblies 128 may be slidably supported by bushings, bearings, and the like (not shown) coupled to the intermediate arms 118, and may be lockable in and/or between the collapsed position 128A and the extended position 128B via respective front handle locks 134 (see FIG. 2).

Here, a caregiver may engage the front handle locks 134 (not shown in detail) to facilitate moving the front handle assemblies 128 between the collapsed position 128A and the extended position 128B. The front handle assemblies 128 are generally arranged so as to be engaged by a caregiver during patient transport up or down stairs ST when in the extended position 128B. It will be appreciated that the front handle assemblies 128 could be of various types, styles, and/or configurations suitable to be engaged by caregivers to support the patient transport system 100 for movement. While the illustrated front handle assemblies 128 are arranged for telescoping movement, other configurations are contemplated. By way of non-limiting example, the front handle assemblies 128 could be pivotably coupled to the support structure 102 or other parts of the patient transport system 100. In some versions, the front handle assemblies 128 could be configured similar to as is disclosed in U.S. Pat. No. 6,648,343, the disclosure of which is hereby incorporated by reference in its entirety.

The pivoting handle assemblies 130 are coupled to the respective rear uprights 114A,114B of the rear support assembly 108, and are movable relative to the rear uprights 114A,114B between a stowed position 130A and an engagement position 130B. Like the front handle assemblies 128, the pivoting handle assemblies 130 are generally arranged for engagement by a caregiver during patient transport, and may advantageously be utilized in the engagement position 130B when the patient transport system 100 operates in the chair configuration CC to transport the patient along floor surfaces FS. In some versions, the pivoting handle assemblies 130 could be configured similar to as is disclosed in U.S. Pat. No. 6,648,343, previously incorporated by reference. Other configurations are contemplated.

As is best depicted in FIG. 6B, the rear uprights 114A,114B each generally extend between a lower upright end 115A and an upper upright end 115B, with the hub axis HA arranged adjacent to the lower upright end 115A. The lower upright end 115A is supported for movement within the hub 158, which may comprise a hollow profile or recess defined by multiple hub housing components. In the illustrated version, the hub axis HA is arranged generally vertically between the rear arm axis RAA and the wheel axis WA. The rear uprights 114A,114B may each comprise a generally hollow, extruded profile which supports various components of the patient transport system 100.

As best shown in FIG. 2, the handle assembly 132 includes an upper grip 136. The upper grip 136 is operatively attached to a first extension post 138A. The first extension post 138A is disposed within the first rear upright 114A. Accordingly, the first extension post 138A supports the upper grip 136 for movement of the handle assembly 132 between a collapsed position 132A where the upper grip is disposed adjacent to the user interface (see FIG. 2 and an extended position 132B where the upper grip is spaced from the user interface (see FIG. 1). In some examples, the upper grip 136 may extend between a first upper grip end 136A and a second upper grip end 136B. The first extension post 138A may be operatively attached to the first upper grip end 136A. The handle assembly 132 may further include a second extension post 138B operatively attached to the second upper grip end 136B. Together, the first and second extension posts 138A,138B may support the upper grip 136 for movement of the handle assembly 132 between the collapsed position 132A and the extended position 132B.

In the representative version illustrated herein, the upper grip 136 generally comprises a first hand grip region 144 arranged adjacent to the first extension posts 138A, and a second hand grip region 146 arranged adjacent to the second extension post 138B, each of which may be engaged by the caregiver to support the patient transport system 100 for movement, such as during patient transport up or down stairs ST (see FIGS. 9A-9F). The activation input controls 214 may be arranged in various locations about the patient transport system 100. In the illustrated versions, a first activation input control 222 is disposed adjacent to the first hand grip region 144 of the handle assembly 132, and a second activation input control 224 is disposed adjacent to the second hand grip region 146 (best shown in FIG. 2). In the illustrated version, the user interface 204 is configured such that the caregiver can engage either of the activation input controls 222, 224 with a single hand grasping the upper grip 136 (described below) of the handle assembly 132 during use.

The activation input controls 214 may be arranged between the first and second hand grip regions 144, 146 in order to facilitate user engagement of the activation input controls 214 from either of the first and second hand grip regions 144, 146. As previously discussed, the activation input controls 214 include the first activation input control 222 and the second activation input control 224. The first activation input control 222 may be disposed adjacent the first hand grip region 144 so as to facilitate user engagement of the first activation input control 222 from the first hand grip region 144. The second activation input control 224 may be disposed adjacent to the second hand grip region 146 so as to facilitate user engagement of the second activation input control 224 from the second hand grip region 146. Here, it will be appreciated that the user can engage either of the first and second hang grip regions 144, 146 with one of their hands to support the patient transport system 100 while, at the same, using that same hand to activate one of the first and second activation input controls 222, 224 (e.g., reaching with their thumb).

The first activation input control 222 and the second activation input control 224 may be spaced apart by a predetermined distance (e.g., several inches) and are wired in parallel in some versions (not shown in detail).

Referring to FIGS. 6A through 6C, the handle assembly 132 is configured for movement between the extended position 132B (shown in FIG. 6A) where the upper grip 136 is spaced from the user interface 204 at a first distance D1, and the collapsed position 132A (shown in FIG. 6C) where the upper grip 136 is disposed adjacent to the user interface 204. Additionally, the handle assembly 132 may be configured for movement to an intermediate position 132C (shown in FIG. 6B) where the upper grip 136 is spaced from the user interface 204 at a second distance D2, less than the first distance D1.

As noted above, the patient transport system 100 is configured for use in transporting the patient across floor surfaces FS, such as when operating in the stair configuration SC, and for transporting the patient along stairs ST when operating in the stair configuration SC. To these ends, the illustrated patient transport system 100 includes a carrier assembly 148 arranged for movement relative to the support structure 102 between the chair configuration CC and the stair configuration ST. The carrier assembly 148 generally comprises at least one shaft 150 defining a wheel axis WA, one or more rear wheels 152 supported for rotation about the wheel axis WA, at least one track assembly 154 having a belt 156 for engaging stairs ST, and one or more hubs 158 supporting the shaft 150 and the track assembly 154 and the shaft 150 for concurrent pivoting movement about a hub axis HA. Here, movement of the carrier assembly 148 from the chair configuration CC (see FIG. 2) to the stair configuration SC (see FIGS. 1 and 6B) simultaneously deploys the track assembly 154 for engaging stairs ST with the belt 156 and moves the wheel axis WA longitudinally closer to the front support assembly 110 so as to position the rear wheels 152 further underneath the seat section 104 and closer to the front wheels 122.

As is described in greater detail below in connection with FIGS. 9A-9F, the movement of the rear wheels 152 relative to the front wheels 122 when transitioning from the chair configuration CC to the stair configuration SC that is afforded by the patient transport system 100 of the present disclosure affords significant improvements in patient comfort and caregiver usability, in that the rear wheels 152 are arranged to promote stable transport across floor surfaces FS in the chair configuration CC but are arranged to promote easy transitioning from floor surfaces to stairs ST as the patient transport system 100 is “tilted” backwards about the rear wheels 152 (compare FIGS. 9D-9F). Put differently, positioning the rear wheels 152 relative to the front wheels 122 consistent with the present disclosure makes “tilting” the patient transport system 100 significantly less burdensome for the caregivers and, at the same time, much more comfortable for the patient due to the arrangement of the patient's center of gravity relative to the portion of the rear wheels 152 contacting the floor surface FS as the patient transport system 100 is “tilted” backwards to transition into engagement with the stairs ST.

In the representative versions illustrated herein, the carrier assembly 148 comprises hubs 158 that are pivotably coupled to the respective rear uprights 114A,114B for concurrent movement about the hub axis HA. Here, one or more bearings, bushings, shafts, fasteners, and the like (not shown in detail) may be provided to facilitate pivoting motion of the hubs 158 relative to the rear uprights 114A,114B. Similarly, bearings and/or bushings (not shown) may be provided to facilitate smooth rotation of the rear wheels 152 about the wheel axis WA. Here, the shafts 150 may be fixed to the hubs 158 such that the rear wheels 152 rotate about the shafts 150 (e.g., about bearings supported in the rear wheels 152), or the shafts 150 could be supported for rotation relative to the hubs 158. Each of the rear wheels 152 is also provided with a wheel lock 160 coupled to its respective hub 158 to facilitate inhibiting rotation about the wheel axis WA. The wheel locks 160 are generally pivotable relative to the hubs 158, and may be configured in a number of different ways without departing from the scope of the present disclosure. While the representative version of the patient transport system 100 illustrated herein employs hubs 158 with “mirrored” profiles that are coupled to the respective rear uprights 114A, 114B and support discrete shafts 150 and wheel locks 160, it will be appreciated that a single hub 158 and/or a single shaft 150 could be employed. Other configurations are contemplated.

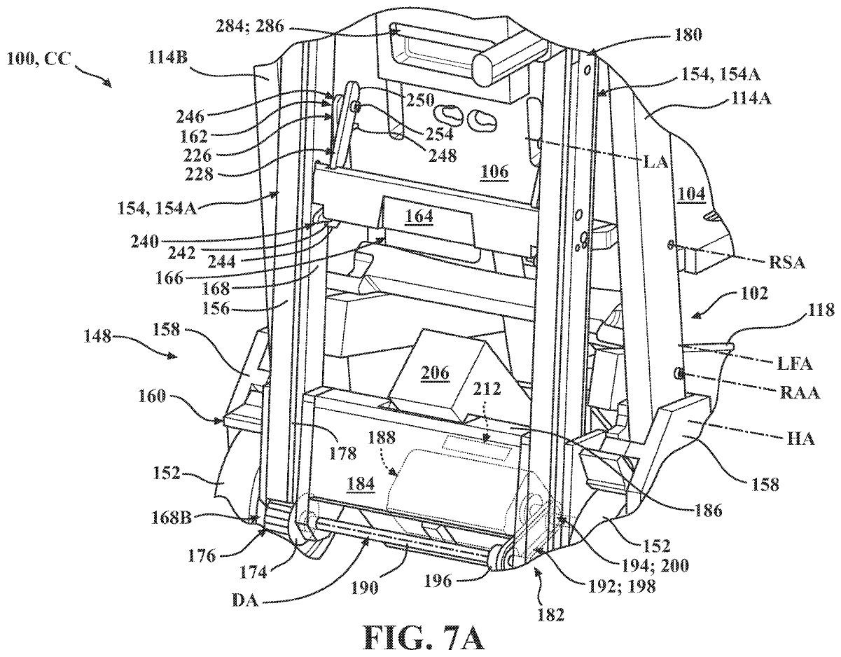

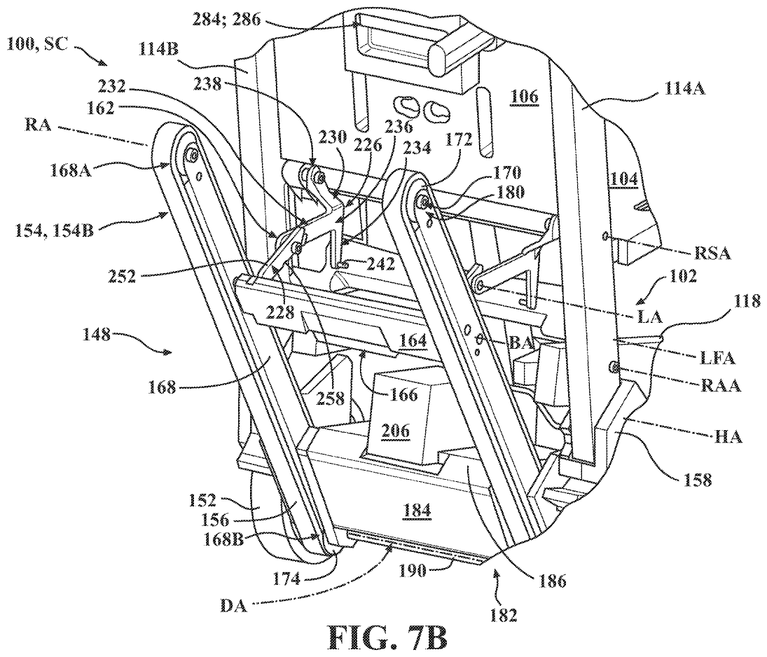

Referring now to FIGS. 7A-7B, as noted above, the track assemblies 154 move concurrently with the hubs 158 between the chair configuration CC and the stair configuration SC. Here, the track assemblies 154 are arranged in a retracted position 154A when the carrier assembly 148 is disposed in the chair configuration CC, and are disposed in a deployed position 154B when the carrier assembly 148 is disposed in the stair configuration SC. As is described in greater detail below, the illustrated patient transport system 100 comprises a deployment linkage 162 and a deployment lock mechanism 164 with a deployment lock release 166 arranged for engagement by the caregiver to facilitate changing between the retracted position 154A and the deployed position 154B (and, thus, between the chair configuration CC and the stair configuration SC).

In the illustrated version, the patient transport system 100 comprises laterally-spaced track assemblies 154 each having a single belt 156 arranged to contact stairs ST. However, it will be appreciated that other configurations are contemplated, and a single track assembly 154 and/or track assemblies with multiple belts 156 could be employed. The track assemblies 154 each generally comprise a rail 168 extending between a first rail end 168A and a second rail end 168B. The second rail end 168B is operatively attached to the hub 158, such as with one or more fasteners (not shown in detail). An axle 170 defining a roller axis RA is disposed adjacent to the first rail end 168A of each rail 168, and a roller 172 is supported for rotation about the roller axis RA. For each of the track assemblies 154, the belt 156 is disposed in engagement with the roller 172 and is arranged for movement relative to the rail 168 in response to rotation of the roller 172 about the roller axis RA.

Adjacent to the second rail end 168B of each rail 168, a drive pulley 174 is supported for rotation about a drive axis DA and is likewise disposed in engagement with the belt 156 (see FIGS. 7A-7B; rotation about drive axis DA not shown in detail). Here, the drive pulley 174 comprises outer teeth 176 which are disposed in engagement with inner teeth 178 formed on the belt 156. The track assemblies 154 each also comprise a belt tensioner, generally indicated at 180, configured to adjust tension in the belt 156 between the roller 172 and the drive pulley 174.

In the representative version illustrated herein, the patient transport system 100 comprises a drive system, generally indicated at 182, configured to facilitate driving the belts 156 of the track assemblies 154 relative to the rails 168 to facilitate movement of the patient transport system 100 up and down stairs ST. To this end, and as is depicted in FIG. 7A, the drive system 182 comprises a drive frame 184 and a cover 186 which are operatively attached to the hubs 158 of the carrier assembly 148 for concurrent movement with the track assemblies 154 between the retracted position 154A and the deployed position 154B. A motor 188 (depicted in phantom in FIG. 7A) is coupled to the drive frame 184 and is concealed by the cover 186. The motor 188 is configured to selectively generate rotational torque used to drive the belts 156 via the drive pulleys 174, as described in greater detail below. To this end, a drive axle 190 is coupled to each of the drive pulleys 174 and extends along the drive axis DA laterally between the track assemblies 154. The drive axle 190 is rotatably supported by the drive frame 184, such as by one or more bearings, bushings, and the like (not shown in detail). A geartrain 192 is disposed in rotational communication between the motor 188 and the drive axle 190. To this end, in the version depicted in FIG. 7A, the geartrain 192 comprises a first sprocket 194, a second sprocket 196, and an endless chain 198. Here, the motor 188 comprises an output shaft 200 to which the first sprocket 194 is coupled, and the second sprocket 196 is coupled to the drive axle 190. The endless chain 198, in turn, is supported about the first sprocket 194 and the second sprocket 196 such that the drive axle 190 and the output shaft 200 rotate concurrently. The geartrain 192 may be configured so as to adjust the rotational speed and/or torque of the drive axle 190 relative to the output shaft 200 of the motor, such as by employing differently-configured first and second sprockets 194, 196 (e.g., different diameters, different numbers of teeth, and the like).

While the representative version of the drive system 182 illustrated herein utilizes a single motor 188 to drive the belts 156 of the track assemblies 154 concurrently using a chain-based geartrain 192, it will be appreciated that other configurations are contemplated. By way of non-limiting example, multiple motors 188 could be employed, such as to facilitate driving the belts 156 of the track assemblies 154 independently. Furthermore, different types of geartrains 192 are contemplated by the present disclosure, including without limitation the geartrains 192 which comprise various arrangements of gears, planetary gearsets, and the like.

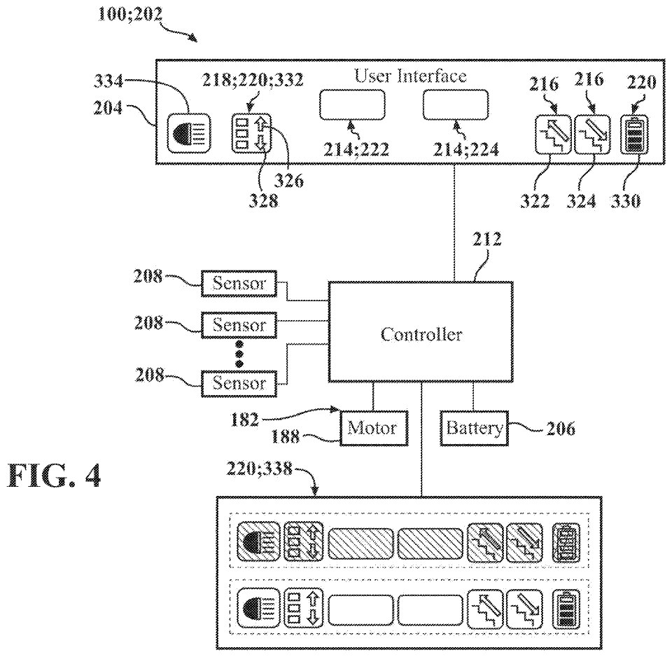

The patient transport system 100 comprises a control system 202 to, among other things, facilitate control of the track assemblies 154. To this end, and as is depicted schematically in FIG. 4, the representative version of the control system 202 generally comprises a user interface 204, a battery 206, one or more sensors 208, and one or more back light modules 210 which are disposed in electrical communication with a controller 212. As will be appreciated from the subsequent description below, the controller 212 may be of a number of different types, styles, and/or configurations, and may employ one or more microprocessors for processing instructions or an algorithm stored in memory to control operation of the motor 188, the light modules 210, and the like. Additionally or alternatively, the controller 212 may comprise one or more sub-controllers, microcontrollers, field programmable gate arrays, systems on a chip, discrete circuitry, and/or other suitable hardware, software, and/or firmware that is capable of carrying out the functions described herein.

The controller 212 is coupled to various electrical components of the patient transport system 100 (e.g., the motor 188) in a manner that allows the controller 212 to control or otherwise interact with those electrical components the (e.g., via wired and/or wireless electrical communication). In some versions, the controller 212 may generate and transmit control signals to the one or more powered devices, or components thereof, to drive or otherwise facilitate operating those powered devices, or to cause the one or more powered devices to perform one or more of their respective functions.

The controller 212 may utilize various types of sensors 208 of the control system 202, including without limitation force sensors (e.g., load cells), timers, switches, optical sensors, electromagnetic sensors, motion sensors, accelerometers, potentiometers, infrared sensors, ultrasonic sensors, mechanical limit switches, membrane switches, encoders, and/or cameras. One or more sensors 208 may be used to detect mechanical, electrical, and/or electromagnetic coupling between components of the patient transport system 100. Other types of sensors 208 are also contemplated. Some of the sensors 208 may monitor thresholds movement relative to discrete reference points. The sensors 208 can be located anywhere on the patient transport system 100, or remote from the patient transport system 100. Other configurations are contemplated.

The battery 206 provides power to the controller 212, the motor 188, the light modules 210, and other components of the patient transport system 100 during use, and is removably attachable to the cover 186 of the drive system 182 in the illustrated version (see FIG. 7A; attachment not shown in detail). The user interface 204 is generally configured to facilitate controlling the drive direction and drive speed of the motor 188 to move the belts 156 of the track assembly 154 and, thus, allow the patient transport system 100 to ascend or descend stairs ST. Here, the user interface 204 may comprise one or more activation input controls 214 to facilitate driving the motor 188 in response to engagement by the caregiver, one or more direction input controls 216 to facilitate changing the drive direction of the motor 188 in response to engagement by the caregiver, and/or one or more speed input controls 218 to facilitate operating the motor 188 at different predetermined speeds selectable by the caregiver. The one or more direction input controls 216 and the one or more speed input controls 218 may be coupled to the rear support assembly 108 and referred to as lower input controls 219. The user interface 204 may also comprise various types of indicators 220 to display information to the caregiver. It will be appreciated that the various components of the control system 202 introduced above could be configured and/or arranged in a number of different ways, and could communicate with each other via one or more types of electrical communication facilitated by wired and/or wireless connections. Other configurations are contemplated.

In the illustrated versions, the patient transport system 100 is configured to limit movement of the belts 156 relative to the rails 168 during transport along stairs ST in an absence of engagement with the activation input controls 214 by the caregiver. Put differently, one or more of the controller 212, the motor 188, the geartrain 192, and/or the track assemblies 154 may be configured to “brake” or otherwise prevent movement of the belts 156 unless the activation input controls 214 are engaged. To this end, the motor 188 may be controlled via the controller 212 to prevent rotation (e.g., driving with a 0% pulse-width modulation PWM signal) in some versions. However, other configurations are contemplated, and the patient transport system 100 could be configured to prevent movement of the belts 156 in other ways. By way of non-limiting example, a mechanical brake system (not shown) could be employed in some versions.

Referring now to FIG. 7A, the patient transport system 100 employs the deployment lock mechanism 164 to releasably secure the track assembly 154 in the retracted position 154A and in the deployed position 154B. The deployment lock release 166 is arranged for engagement by the caregiver to move between the retracted position 154A and the deployed position 154B. The deployment lock mechanism 164 is coupled to the track assemblies 154 for concurrent movement, and the deployment linkage 162 is coupled between the deployment lock mechanism 164 and the support structure 102. The illustrated deployment linkage 162 generally comprises connecting links 226 which are pivotably coupled to the support structure 102, and brace links 228 which are coupled to the deployment lock mechanism 164 and are respectively pivotably coupled to the connecting links 226.

The connecting links 226 each comprise or otherwise define a forward pivot region 230, a connecting pivot region 232, a trunnion region 234, and an interface region 236. The forward pivot regions 230 extend from the interface regions 236 to forward pivot mounts 238 which are pivotably coupled to the rear uprights 114A, 114B about the rear seat axis RSA, such as by one or more fasteners, bushings, bearings, and the like (not shown in detail). Here, because the rear uprights 114A,114B are spaced laterally away from each other at a distance large enough to allow the track assemblies 154 to “nest” therebetween in the retracted position 154A (see FIG. 7A), the forward pivot regions 230 of the connecting links 226 extend at an angle away from the rear uprights 114A, 114B at least partially laterally towards the track assemblies 154.

The trunnion regions 234 extend generally vertically downwardly from the interface regions 236 to trunnion mount ends 240, and comprise trunnions 242 which extend generally laterally and are arranged to abut trunnion catches 244 of the deployment lock mechanism 164 to retain the track assemblies 154 in the retracted position 154A (see FIG. 7A). The connecting pivot regions 232 extend longitudinally away from the interface regions 236 to rearward pivot mounts 246 which pivotably couple to the brace links 228 about a link axis LA. The connecting links 226 are each formed as separate components with mirrored profiles in the illustrated versions, but could be realized in other ways, with any suitable number of components.

The brace links 228 each generally extend between an abutment link end 250 and a rearward link mount 252, with a forward link mount 254 arranged therebetween. The forward link mounts 254 are pivotably coupled to the rearward pivot mounts 246 of the connecting links 226 about the link axis LA, such as by one or more fasteners, bushings, bearings, and the like (not shown in detail). The rearward link mounts 252 are each operatively attached to the deployment lock mechanism 164 about a barrel axis BA. The brace links 228 each define a link abutment surface 256 disposed adjacent to the abutment link end 250 which are arranged to abut the link stops 248 of the connecting links 226 in the deployed position 154B (see FIG. 7B). The brace links 228 also define a relief region 258 formed between the forward link mount 254 and the rearward link mount 252. The relief regions 258 are shaped to at least partially accommodate the link stops 248 of the connecting links 226 when the track assemblies 154 are in the retracted position 154A (not shown in detail). The deployment linkage 162, the deployment lock mechanism 164, and the deployment lock release 166 may be similar to as is disclosed by U.S. Patent Application Publication No. 20210196536, the disclosure of which is hereby incorporated by reference in its entirety.

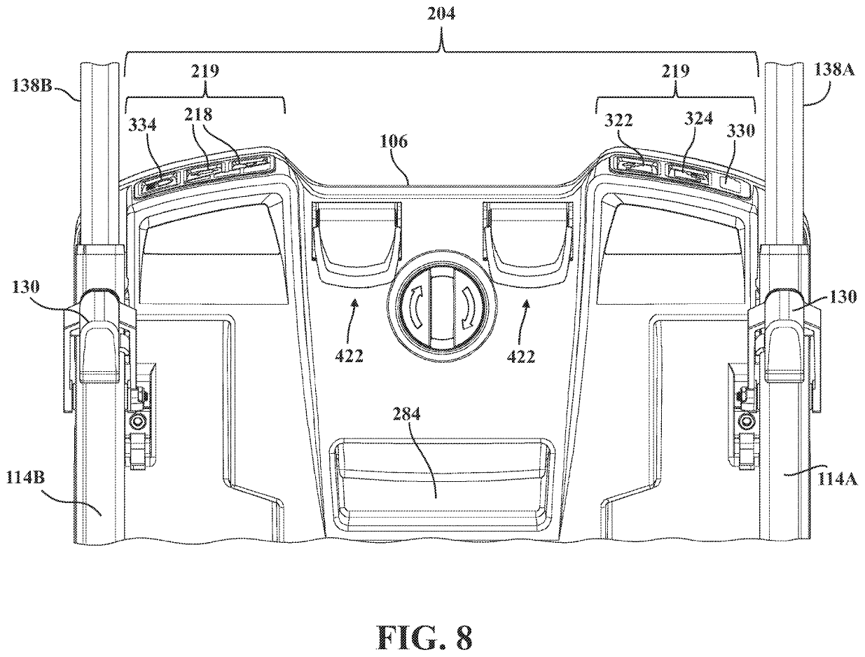

With continued reference to FIGS. 7A and 7B and additional reference to FIG. 8, the patient transport system 100 employs a folding lock mechanism 284 to facilitate changing between the stowed configuration WC (see FIG. 5) and the chair configuration CC (see FIG. 6A). To this end, the folding lock mechanism 284 generally comprises a folding lock release 286 operatively attached to the back section 106 and arranged for engagement by the caregiver to releasably secure the folding lock mechanism 284 between a stow lock configuration to maintain the stowed configuration WC, and a use lock configuration to prevent movement to the stowed configuration WC from the chair configuration CC or from the stair configuration SC. The folding lock mechanism 284 may incorporate features as disclosed in U.S. Pat. No. 6,648,343 previously incorporated by reference and as disclosed in U.S. Patent Application Publication No. 20210196536, previously incorporated by reference.

The drive system 182 may include various components not specifically illustrated or be configured in various ways not discussed in detail but described in U.S. Patent Application Publication No. 20210196536, previously referenced and incorporated by reference. In a version, the motor 188 may be supported on an adjustable platform that is movable relative to the drive frame 184 to adjust slack in the endless chain. This arrangement helps to optimize power density and minimize weight in the drive system 182. It will be appreciated that this arrangement could be utilized with other types of geartrains 192, such as where a belt drive (not shown) would replace the endless chain 198. Other configurations are contemplated.

In some versions, the geartrain 192 may be configured with a direct drive gearbox coupled to one of the rails 168 of the track assembly 154. Here, the drive axle 190 extends through the direct drive gearbox, and the motor 188 may be coupled to the direct drive gearbox. In some versions, the patient transport system 100 may include a “passive brake” that allows the speed of the patient transport system 100 to be controlled when on stairs ST even when the battery 206 is of low charge, dead, or not connected to the drive system 182 (e.g., inadvertently removed).

FIGS. 9A-9F successively depict exemplary steps of transporting a patient supported on the patient transport system 100 down the stairs ST. In FIG. 9A, a first caregiver is shown engaging the pivoting handle assemblies 130 in the engagement position 130B to illustrate approaching stairs ST while the patient transport system 100 is moved along floor surfaces FS in the chair configuration CC. In FIG. 9B, the patient transport system 100 has been moved closer to the stairs with a second caregiver engaging the front handle assemblies 128 after having moved them to the extended position 128B. The deployment lock release 166 was also deployed by the first caregiver to move the patient transport system 100 into the stair configuration SC as shown. As shown in the stair configuration SC, the track assemblies 154 are arranged in the deployed position 154B. Here, the rear wheels 152 are positioned significantly closer to the front wheels 122 compared to operation in the chair configuration CC, and are also arranged further under the seat section 104. It will be appreciated that transitioning the patient transport system 100 from the chair configuration CC to the stair configuration SC has resulted in minimal patient movement relative to the support structure 102 as the carrier assembly 148 pivots about the hub axis HA and moves the rear wheels 152 closer to the front wheels 122 in response to movement of the track assemblies 154 to the deployed position 154B.

Furthermore, while the arrangement of the patient's center of gravity has not changed significantly relative to the support structure 102, the longitudinal distance which extends between the patient's center of gravity and the location at which the rear wheels 152 contact the floor surface FS has shortened considerably. Because of this, the process of “tilting” the patient transport system 100 (e.g., about the rear wheels 152) to transition toward contact between the track assemblies 154 and the stairs ST, as depicted in FIG. 9C, is significantly more comfortable for the patient than would otherwise be the case if the patient transport system 100 were “tilted” about the rear wheels 152 from the chair configuration CC (e.g., with the rear wheels 152 positioned further away from the front wheels 122). Put differently, the arrangement depicted in FIG. 9C is such that the patient is much less likely to feel uncomfortable, unstable, or as if they are “falling backwards” during the “tilting” process. Here too, the caregivers are afforded with similar advantages in handling the patient transport system 100, as the arrangement of the rear wheel 152 described above also makes the “tilting” process easier to control and execute. In FIG. 9D, the caregivers are shown continuing to support the patient transport system 100 in the stair configuration SC as the belts 156 of the track assemblies 154 are brought into contact with the edge of the top stair ST.

In FIGS. 9E and 9F, the caregivers are shown continuing to support the patient transport system 100 in the stair configuration SC as the belts 156 of the track assemblies 154 contact multiple stairs ST during descent The patient transport system 100 is configured to operate in a variety of states and modes in certain versions, including for example in or between one or more inactive states SI and/or one or more active states SA. During the inactive state SI, power consumption of the patient transport system 100 is limited as the motor is not controlling movement of the belt during this state, and during the active state SA the controller 212 may be utilized to control movement of the belt 156 with the motor 188 of the patient transport system 100.

It will be appreciated that the controller 212 may be configured to operate in a variety of inactive states SI and active states SA. The controller 212 may be configured to operate in (or between) a sleep mode MS of the inactive state SI and an active mode MS of the inactive state SI. The controller 212 may also operate in a variety of inactive states, for example, a low charge mode MLC of the inactive state SI, and/or a battery disconnect mode MBD of the inactive state SI which are discussed in detail in U.S. Patent Application Publication No. 20210196539A1, the disclosure of which is hereby incorporated by reference in its entirety.

During the sleep mode MS of the inactive state SI, power consumption of the patient transport system 100 is limited. In some versions, power consumption of the patient transport system 100 may be limited by only allowing the controller 212 to provide power from the battery 206 to certain components of the patient transport system 100. For example, during the sleep mode MS, the controller 212 may be unable to generate and transmit control signals to some of the one or more powered devices, or components thereof, to drive the patient transport system 100. Here, however, the controller 212 may be configured to provide power to the user interface 204. In the sleep mode MS, the user interface 204 may be prevented from emitting light, but may be configured to receive input generate by user engagement of any portion of the user interface 204. Additionally, in some instances of the sleep mode MS, one or more of the controller 212, the motor 188, the geartrain 192, and/or the track assemblies 154 may also be configured to “brake” or otherwise prevent movement of the belts 156.

During active mode MA of the inactive state, the controller 212 may not limit power consumption of any component of the patient transport system 100. For example, the user interface 204 may emit light for a predetermined period of time in response to user engagement of one of the input controls 214, 216, 218, 222, 224, 322, 324, 326, 328, and 334. Various other components of the patient transport system 100 may be provided power upon demand without limitation during the active mode MA of the inactive state SI.

The controller 212 may be configured to operate in a drive mode MD during the active state SA to control a direction of movement of the belt 156. In some versions, the controller 212 may be configured to additionally operate in additional modes to the drive mode during the active state SA such as a hold mode MH of the active state SA for limiting movement of the belt 156 to facilitate a controlled descent of the patient transport system 100 along stairs ST. The hold mode is disclosed by the discussed in detail in U.S. Patent Application Publication No. 20210196539A1, previously incorporated by reference.

In some versions, the user interface 204 may comprise one or more light modules 210 realized as backlight modules 338 arranged to illuminate various input controls 214, 216, 218, 222, 224, 322, 324, 326, 328, 334 and/or indicators 220, 330, 32 under certain operating conditions. In some versions, the user interface 204 may comprise one or more light modules 210 configured to, among other things, provide status information to the caregiver.

In the representative version illustrated herein, the controller 212 may be operable in sleep mode in which power consumption is limited, and the active mode SA in which power consumption is not limited such as when the controller 212 controls movement of the belt 156 with the motor 188 of the patient transport system 100. As previously described, the controller 212 may be configured to operate in a variety of other modes/states not explicitly discussed herewith but discussed in greater detail in U.S. Patent Application Publication No. 20210196539A1, previously incorporated by reference.

As noted above, the direction input controls 216 may include the first direction input control 322 and the second direction input control 324. Here, the first direction input control 322 may be configured to select a drive direction of the motor 188 in order to ascend stairs. The second direction input control 324 may be configured to select a drive direction of the motor 188 in order to descend stairs.

The one or more speed input controls 218 may be configured to select between the plurality of drive speeds DS1, DS2, DS3 of the motor 188. The speed indicator 332 may be disposed adjacent to the one or more speed input controls 218. The speed indicator 332 may be configured to display the selected one of the plurality of drive speeds DS1, DS2, DS3 of the motor 188 to the user.

The plurality of drive speeds DS1, DS2, DS3 may correspond to predetermined speed settings (a specific RPM setting) stored in memory of the controller 212. The plurality of drive speeds DS1, DS2, DS3 may include a first drive speed DS1, a second drive speed DS2, and a third drive speed DS3. The first drive speed DS1 corresponds to the lowest of the plurality of drive speeds DS1, DS2, DS3. The third drive speed DS3 corresponds to the highest drive speed of the plurality of drive speeds DS1, DS2, DS3. The second drive speed DS2 corresponds to a speed in between the first drive speed DS1 and the third drive speed DS3. It will be appreciated that the forgoing are non-limiting, illustrative examples of three discreet drive speeds, and other configurations are contemplated, including without limitation additional and/or fewer drive speeds, drive speeds defined in other ways, and the like.

As noted above, the one or more speed input controls 218 may include a first speed input control 326 and a second speed input control 328. The controller 212 may be configured to increase the selected speed to the next higher drive speed setting in response to the user engagement of the first speed input control 326. For example, in response to receiving user input generated by user engagement of the first speed input control 326 when the current selected drive speed is the first drive speed DS1, the controller 212 may set the current speed to the second drive speed DS2. The controller 212 may be configured to decrease the selected drive speed to the next lower drive speed setting in response to user engagement of the second speed input control 328. For example, when the current selected drive speed is the second drive speed DS2, the controller 212 may set the current speed to the first drive speed DS1 in response to user engagement of the second speed input control 328.

In some versions, the controller 212 may be configured to initially select the first drive speed DS1 of the plurality of drive speeds DS1, DS2, DS3 in response to user engagement of the direction input controls 216 following the change in operation from the inactive state SI to the active state SA. However, it is contemplated that the controller 212 may be configured alternatively, such as to initially select the second drive speed DS2 or the third drive speed DS3 of the plurality of drive speeds DS1, DS2, DS3.

The controller 212 may be configured to selectively permit operation of the motor 188 in response to receiving user input generated by engagement of one of the activation input controls 214 (e.g., the first activation input control 222 or the second activation input control 224). For example, the controller 212 may be configured to permit operation of the motor 188 in response to user engagement of at least one of the activation input controls 214 following user engagement of the direction input control 216 to drive the belt 156 in a selected drive direction. In another example, the controller 212 may be configured to permit operation of the motor 188 in response to user engagement of the activation input controls 214 within a predetermined period following engagement of the direction input control 216. After the predetermined period following user engagement of the direction input control 216 has elapsed, the controller 212 may prevent operation of the motor 188 even when one of the activation input controls 214 is engaged. The controller 212 may also be configured to limit operation of the motor 188 in response to receiving the user input before receiving the user input generated by user selection of one of the direction input controls 216.

Referring back to FIG. 1, the patient transport system 100 further includes a head brace 350. The head brace 350 includes a flexible panel 352 extending between a lower region 354 and an upper region 356. The flexible panel 352 may be comprised of a fabric that is surrounded on all sides by a coating. The coating may be applied to the fabric by spraying, lamination, extrusion and/or co-extrusion processes, dipping the fabric into the coating, moving the fabric through the coating, molding the coating onto the fabric, or the like. The coating may comprise polymeric material, such as polyurethane, or other suitable materials to ease cleaning of the flexible panel 352. The coating may be non-porous and/or non-fibrous. The coating eases cleaning of the flexible panel 352 by providing a smooth, continuous, outer surface for wiping and thereby cleaning (as compared to the fabric). The coating may be waterproof, water-resistant, and/or impervious to contaminants, such as dirt, grease, and body fluids. By coating the fabric with polyurethane or other similar material, users are able to more easily wipe contaminants off the flexible panel 352 as compared to uncoated fabric, which tends to trap such contaminants. It is also contemplated that the fabric may be formed of nylon webbing, polypropylene webbing, cotton webbing, elastic webbing, and the like.

The head brace 350 also includes a lower coupler 358 operatively attached to the lower region 354 of the flexible panel 352 and releasably attached to the rear support assembly 108 of the patient transport system 100. Further, the head brace includes an upper coupler 360 operatively attached to the upper region 356 of the flexible panel 352 and releasably attached to the handle assembly 132. The lower coupler 358 and the upper coupler 360 may comprise any suitable latches, catches, buckles, carabiners, or other suitable connectors for connecting the flexible panel 352 to the handle assembly 132 and/or the rear support assembly 108.

Referring to FIGS. 1 and 6A-6C, movement of the handle assembly 132 to the extended position 132B places tension in the flexible panel 352 to define a head support surface 362 for the patient. Additionally, as best shown in FIGS. 6B and 6C, the flexible panel 352 may be disposed out of tension when the handle assembly 132 is spaced from the extended position 132B such that the flexible panel 352 is flaccid. In other words, as the handle assembly 132 moves away from the extended position 132B, tension is released from the flexible panel 352 such that the flexible panel 352 is no longer pulled taut to define the head support surface 362 for the patient. Accordingly, as shown in FIGS. 6B and 6C, the flexible panel 352 may define a fold 364 in response to movement of the handle assembly 132 toward the collapsed position 132A. In other words, the flexible panel 352 may collapse onto itself as the handle assembly 132 moves toward the collapsed position 132A. While FIGS. 6B and 6C show the flexible panel 352 collapsing backwards such that the fold 364 is arranged toward the track assembly 154, it should be appreciated that in some configurations, the flexible panel 352 may collapse forward (not shown) such that the fold 364 is arranged toward the seat section 104.

The flexible panel 352 may include a front face 366 and a rear face 368. The front face 366 may define the head support surface 362 and face away from the track assembly 154 when the flexible panel 352 is disposed in tension with the handle assembly 132 in the extended position 132B. The rear face 368 of the flexible panel 352 may be opposite the front face 366 and face the track assembly 154 when the flexible panel 352 is disposed in tension with the handle assembly 132 in the extended position 132B. Additionally, as best shown in FIGS. 1, 11, and 14, the flexible panel 352 may define a tapered profile 370 that narrows from the upper region 356 of the flexible panel 352 to the lower region 354 of the flexible panel 352 to define an access region 372 to permit the user to engage the at least one lower input control 219. Referring to FIG. 2, when the handle assembly 132 is arranged toward the collapsed position 132A (i.e., spaced from the extended position 132B) such that the flexible panel 352 defines the fold 364, the tapered profile 370 defining the access region 372 permits the user to engage the at least one lower input control 219.

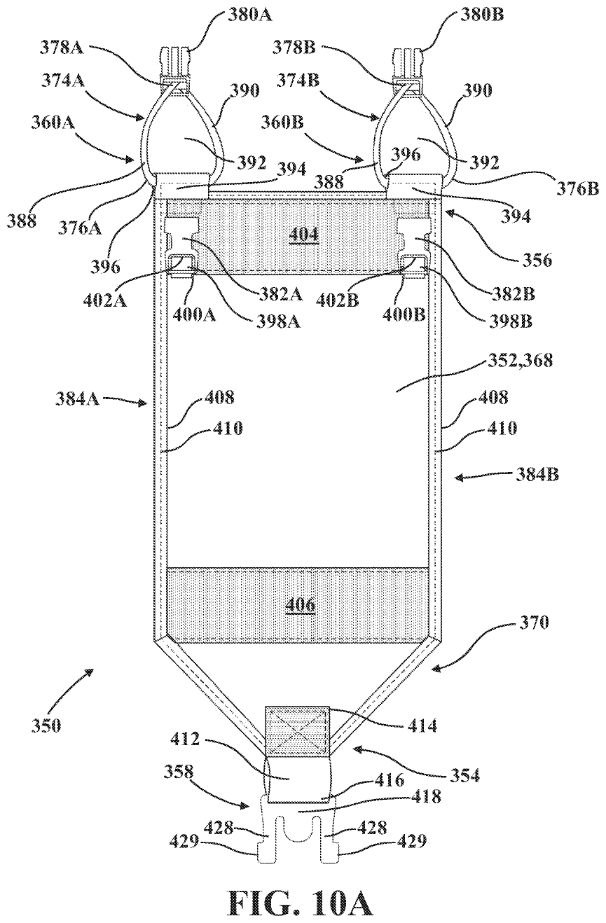

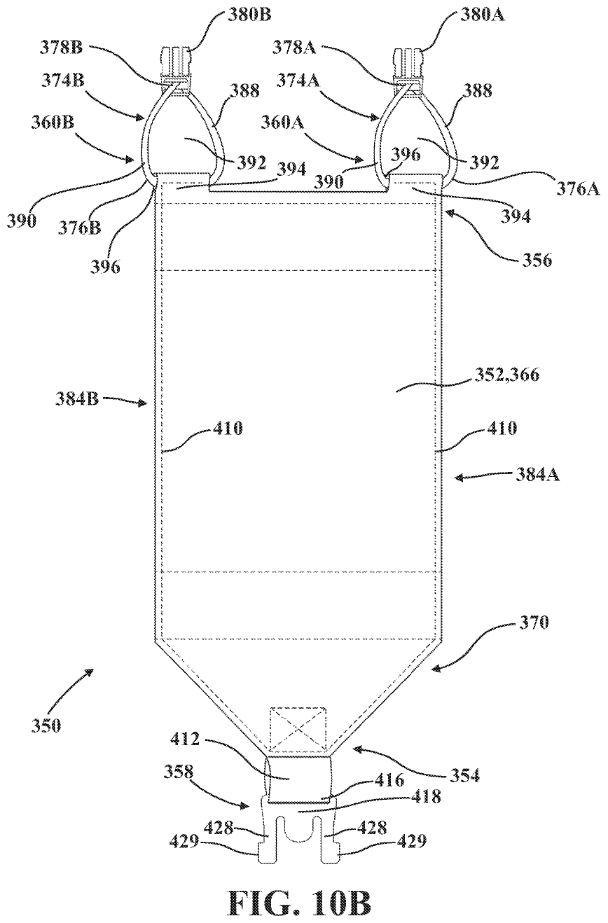

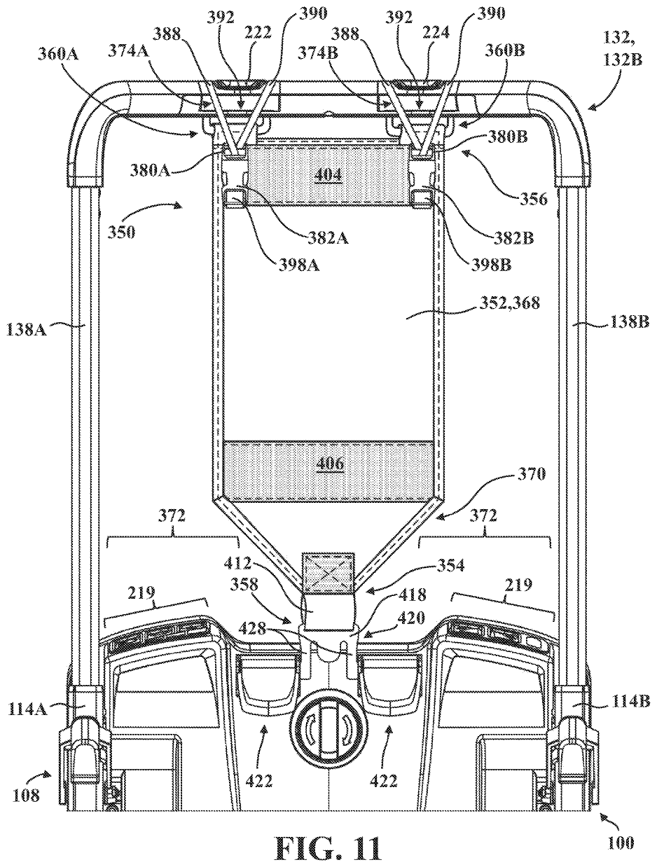

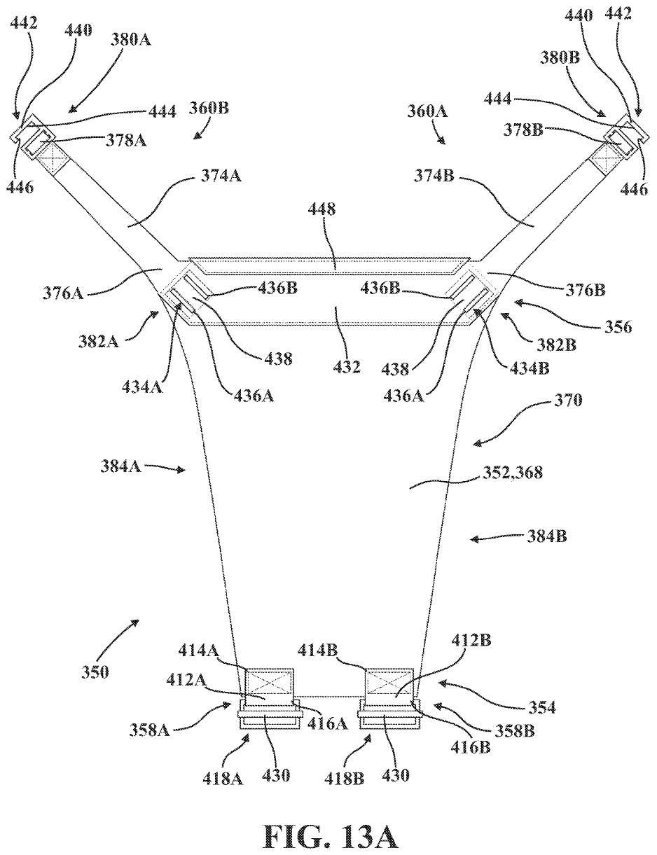

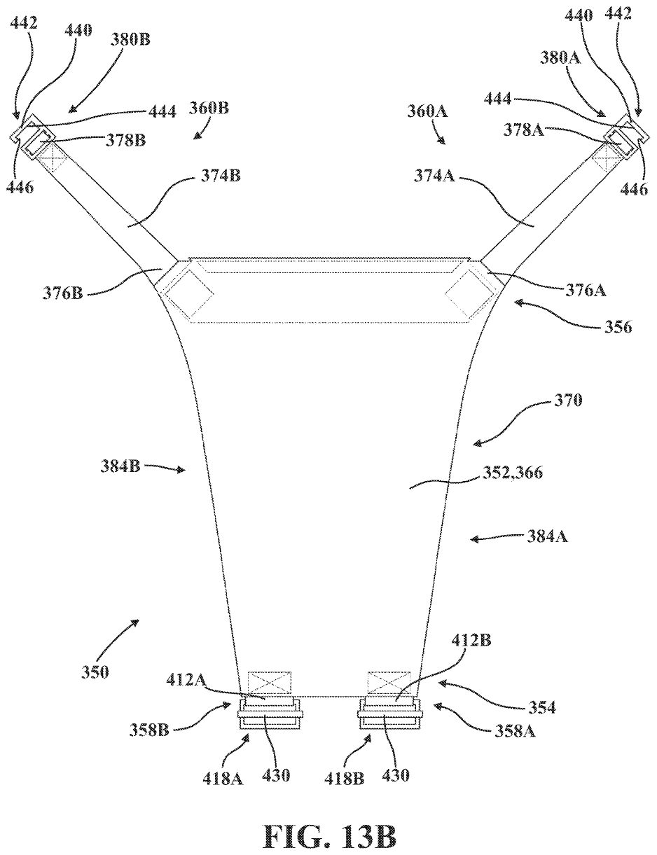

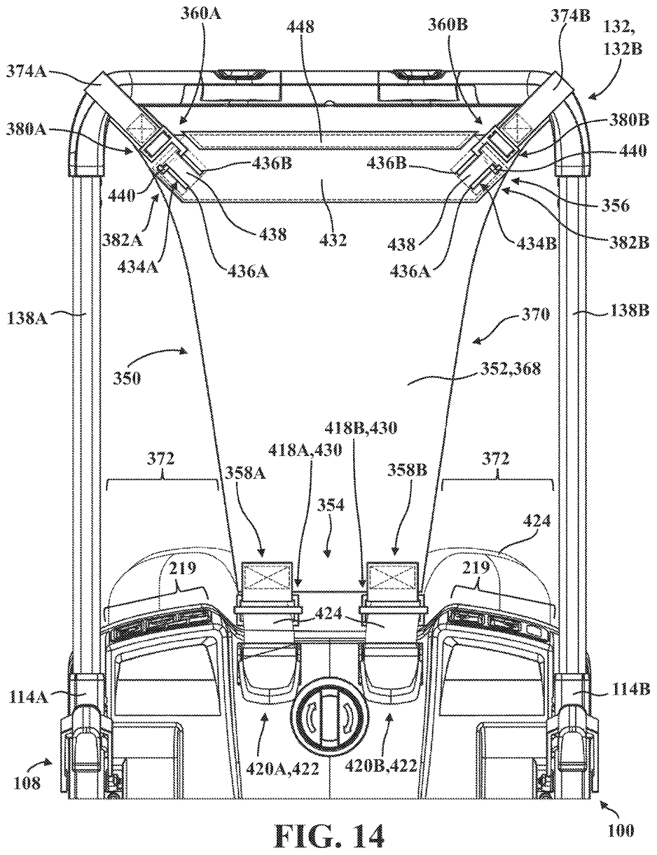

Referring to FIGS. 10A-10B and 13A-13B, the upper coupler 360 may include a latch strap 374. The latch strap 374 may extend between a latch strap mounting end 376 and a latch strap coupling end 378. The latch strap mounting end 376 may be operatively attached to one of the front face 366 and the rear face 368 of the flexible panel 352 at the upper region 356 of the flexible panel 352. A latch 380 may be operatively attached to the latch strap coupling end 378 of the latch strap 374. The upper coupler 360 may further include a catch 382 operatively attached to the other of the front face 366 and the rear face 368 of the flexible panel 352 at the upper region 356 of the flexible panel 352. As best shown in FIGS. 11 and 14, the latch strap 374 may be configured to loop around the handle assembly 132, and the latch 380 may be configured to engage the catch 382 to couple the flexible panel 352 to the handle assembly 132.

With continued reference to FIGS. 10A-11 and 13A-14, the upper coupler 360 may be defined as a first upper coupler 360A. Accordingly, the latch strap 374 may be defined as a first latch strap 374A, the latch strap mounting end 376 may be defined as a first latch strap mounting end 376A, the latch strap coupling end 378 may be defined as a first latch strap coupling end 378A, the latch 380 may be defined as a first latch 380A, and the catch 382 may be defined as a first catch 382A. The first upper coupler 360A may be operatively attached to a first lateral region 384A of the upper region 356 of the flexible panel 352. For example, the first latch strap mounting end 376A may be operatively attached to one of the front face 366 and the rear face 368 of the flexible panel 352 at the first lateral region 384A of the upper region 356 of the flexible panel 352. Similarly, the first catch 382A may be operatively attached to the other of the front face 366 and the rear face 368 of the flexible panel 352 at the first lateral region 384A of the upper region 356 of the flexible panel 352.

With continued reference to FIGS. 10A-11 and 13A-14, the head brace 350 may further include a second upper coupler 360B. The second upper coupler 360B may be operatively attached to a second lateral region 384B of the upper region 356 of the flexible panel 352, opposite the first lateral region 384A. The second upper coupler 360B may include a second latch strap 374B. The second latch strap 374B may extend between a second latch strap mounting end 376B and a second latch strap coupling end 378B. The second latch strap mounting end 376B may be operatively attached to one of the front face 366 and the rear face 368 of the flexible panel 352 at the second lateral region 384B of the upper region 356 of the flexible panel 352. A second latch 380B may be operatively attached to the second latch strap coupling end 378B of the second latch strap 374B. The second upper coupler 360B may further include a second catch 382B operatively attached to the other of the front face 366 and the rear face 368 of the flexible panel 352 at the second lateral region 384B of the upper region 356 of the flexible panel 352. As best shown in FIGS. 11 and 14, the first latch strap 374A and the second latch strap 374B may be configured to loop around the handle assembly 132, and the first latch 380A and the second latch 380B may be configured to engage the first catch 382A and the second catch 382B, respectively, to couple the flexible panel 352 to the handle assembly 132.

The first latch strap 374A and the second latch strap 374B may be comprised of any suitable material. For example, the first latch strap 374A and the second latch strap 374B may be comprised of a fabric that is coated, similar to the flexible panel 352, described above. It is also contemplated that the first latch strap 374A and the second latch strap 374B may be formed of nylon webbing, polypropylene webbing, cotton webbing, elastic webbing, and the like. The first latch strap mounting end 376A of the first latch strap 374A and the second latch strap mounting end 376B of the second latch strap 374B may be operatively attached to the flexible panel 352 in any suitable manner. For example, the first latch strap mounting end 376A of the first latch strap 374A and the second latch strap mounting end 376B of the second latch strap 374B may be stitched to the flexible panel 352 using a stitching pattern such as a box X stitch, double W stitch, diamond stitch, horizontal diamond stitch, the like, or a combination thereof. As another example, the first latch strap mounting end 376A of the first latch strap 374A and the second latch strap mounting end 376B of the second latch strap 374B may be integrally formed as a unitary component with the flexible panel 352.

FIGS. 10A through 11 show one example of the head brace 350. FIG. 10A shows the rear face 368, while FIG. 10B shows the front face 366. FIG. 11B shows the head brace 350 of FIGS. 10A and 10B coupled to the handle assembly 132 and the rear support assembly 108 of the patient transport system 100. In this example, each of the first latch strap 374A and the second latch strap 374B may define a first lateral portion 388, a second lateral portion 390 separate from the first lateral portion 388, and a gap 392 therebetween. Referring to FIG. 11, the gap 392 of the first latch strap 374A is configured to receive the first activation input control 222 such that the first lateral portion 388 and the second lateral portion 390 of the first latch strap 374A straddle the first activation input control 222 to inhibit lateral movement of the first latch strap 374A along the handle assembly 132. Similarly, the gap 392 of the second latch strap 374B is configured to receive the second activation input control 224 such that the first lateral portion 388 and the second lateral portion 390 of the second latch strap 374B straddle the second activation input control 224 to inhibit lateral movement of the second latch strap 374B along the handle assembly 132.

The upper region 356 of the flexible panel 352 may include one or more coupling flaps 394. The coupling flap(s) 394 may extend from the flexible panel 352 and fold over the first latch strap 374A and/or the second latch strap 374B to define one or more latch strap coupling loops 396. Each of the first latch strap 374A and/or the second latch strap 374B may extend through a respective latch strap coupling loop 396 and may be stitched to the respective coupling flap 394 to couple the first latch strap 374A and/or the second latch strap 374B to the flexible panel 352.

Referring again to FIGS. 10A through 11, the first upper coupler 360A may further include a first catch strap 398A. The first catch strap 398A may extend between a first catch strap mounting end 400A and a first catch strap coupling end 402A. The first catch strap mounting end 400A may be operatively attached to the other of the front face 366 and the rear face 368 of the flexible panel 352 at the first lateral region 384A of the upper region 356. The first catch strap coupling end 402A may support the first catch 382A. Similarly, the second upper coupler 360B may further include a second catch strap 398B. The second catch strap 398B may extend between a second catch strap mounting end 400B and a second catch strap coupling end 402B. The second catch strap mounting end 400B may be operatively attached to the other of the front face 366 and the rear face 368 of the flexible panel 352 at the second lateral region 384B of the upper region 356. The second catch strap coupling end 402 B may support the second catch 382B.

The first catch strap 398A and the second catch strap 398B may be comprised of any suitable material. For example, the first catch strap 398A and the second catch strap 398B may be comprised of a fabric that is coated, similar to the flexible panel 352, described above. It is also contemplated that the first catch strap 398A and the second catch strap 398B may be formed of nylon webbing, polypropylene webbing, cotton webbing, elastic webbing, and the like. The first catch strap mounting end 400A of the first catch strap 398A and the second catch strap mounting end 400B of the second catch strap 398B may be operatively attached to the flexible panel 352 in any suitable manner. For example, the first catch strap mounting end 400A of the first catch strap 398A and the second catch strap mounting end 400B of the second catch strap 398B may be stitched to the flexible panel 352 using a stitching pattern such as a box X stitch, double W stitch, diamond stitch, horizontal diamond stitch, the like, or a combination thereof. As another example, the first catch strap mounting end 400A of the first catch strap 398A and the second catch strap mounting end 400B of the second latch strap 398B may be integrally formed as a unitary component with the flexible panel 352.

The head brace 350 may further include webbing, such as that formed by woven fabric, coupled to the front face 366 and/or the rear face 368 of the flexible panel 352. The webbing may comprise polyester webbing or other suitable materials. For example, as shown in FIG. 10A, the head brace 350 may include an upper webbing 404 and/or a lower webbing 406. The upper webbing 404 may be disposed toward the upper region 356 of the flexible panel 352 and over the first catch strap 398A and/or the second catch strap 398B. Accordingly, the upper webbing 404 may couple the first catch strap 398A and/or the second catch strap 398B to the flexible panel 352. The lower webbing 406 may be spaced below the upper webbing 404, such as disposed toward the lower region 354 of the flexible panel 352. For example, the lower webbing 406 may be disposed above the tapered profile 370 of the flexible panel 352. The flexible panel 352 may further include a peripheral hem 408 extending around a periphery of the flexible panel 352. The peripheral hem 408 may be folded over the upper webbing 404 and/or the lower webbing 406. The flexible panel 352 may further include peripheral stitches 410 disposed through the peripheral hem 408, the flexible panel 352, the upper webbing 404, and/or the lower webbing 406.

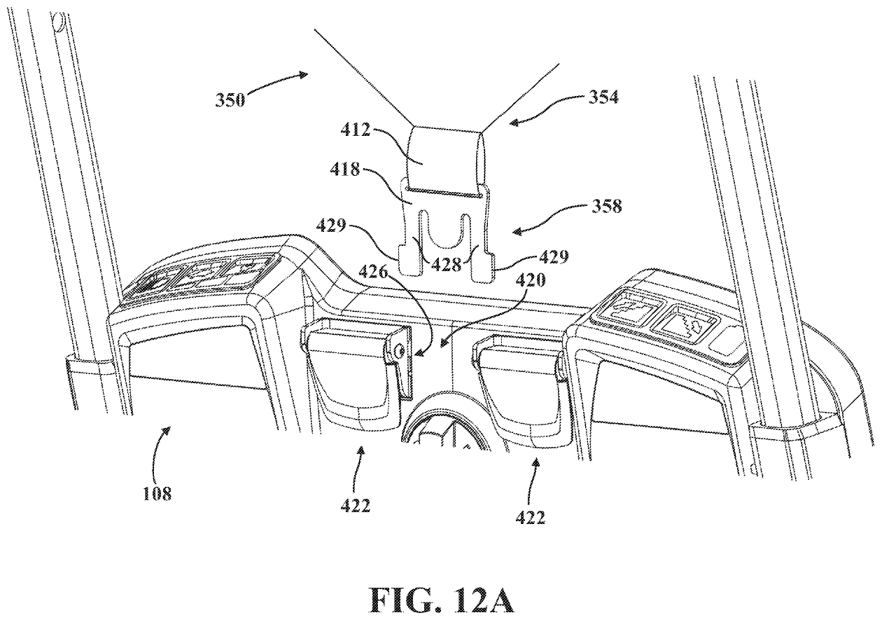

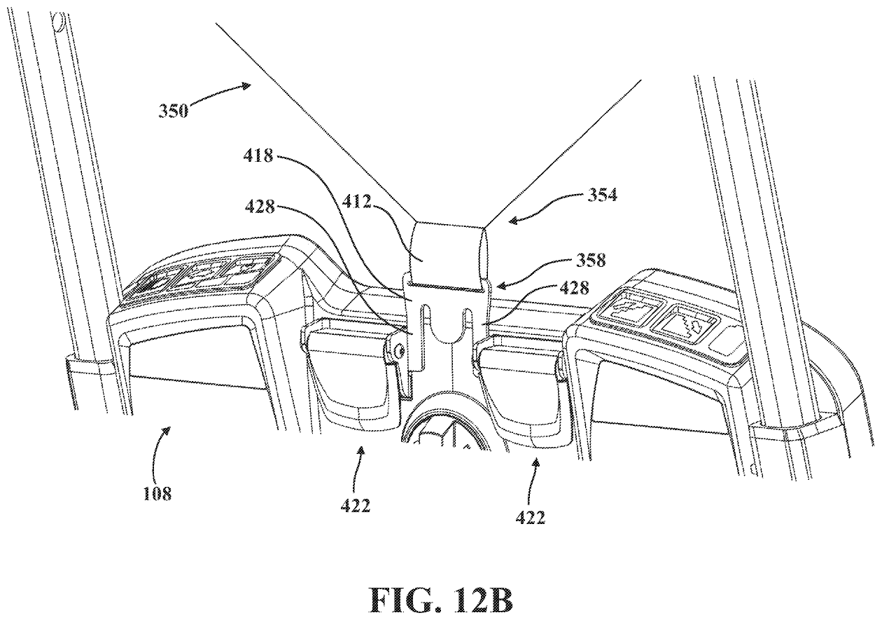

The lower coupler 358 of the head brace 350 may include a lower strap 412 extending between a lower strap mounting end 414 and a lower strap coupling end 416. The lower strap mounting end 414 may be coupled to the lower region 354 of the flexible panel 352. The lower coupler 358 may further include a lower latch 418 operatively attached to the lower strap coupling end 416. The lower latch 418 is configured to engage the rear support assembly 108 to couple the flexible panel 352 to the rear support assembly 108. Referring to FIGS. 12A and 12B, the lower latch 418 of the lower coupler 358 may by operatively attached to the flexible panel 352 (such as directly attached to the flexible panel 352, or attached to the lower strap coupling end 416, as illustrated).

The rear support assembly 108 may define a lower catch 420. For example, the rear support assembly 108 may include a patient containment system including a shoulder strap harnesses 422 configured to receive and retain shoulder straps 424 to restrain the patient. Exemplary patient containment systems are described in U.S. patent application Ser. No. 17/131,954, filed on Dec. 23, 2020, the disclosure of which is hereby incorporated by reference in its entirety. In some examples, each shoulder strap harnesses 422 may define a lower catch void 426 configured to receive the lower latch 418. In some examples, the lower latch 418 may define opposing deflectable prongs 428. Each of the opposing deflectable prongs 428 may include lower latch projections 429 that are releasably engageable with the lower catch voids 426 to couple the lower latch 418 to the shoulder strap harnesses 422, thereby coupling the flexible panel 352 to the lower support assembly 108. FIG. 12A shows the lower latch 418 spaced from the shoulder strap harnesses 422, while FIG. 12B shows the deflectable prongs 428 of the lower latch 418 engaged with the lower catch voids 426 defined by the shoulder strap harnesses 422. Other configurations for coupling the flexible panel 352 to the rear support assembly 108 are contemplated.

In some examples, referring to FIG. 13A through 14, the lower coupler 358 may be further defined as a first lower coupler 358A operatively attached to one of the front face 366 and the rear face 368 of the flexible panel 352 at the first lateral region 384A of the lower region 354 of the flexible panel 352. Accordingly, the lower strap 412 may be further defined as a first lower strap 412A, the lower strap mounting end 414 may be referred to as a first lower strap mounting end 414A, the lower strap coupling end 416 may be referred to as a first lower strap coupling end 416A, and the lower latch 418 may be referred to as a first lower latch 418A. Similarly, the head brace 350 may further include a second lower coupler 358B operatively attached to one of the front face 366 and the rear face 368 of the flexible panel 352 at the second lateral region 384B of the lower region 354 of the flexible panel 352. The second lower coupler 358B may include a second lower strap 412B extending between a second lower strap mounting end 414B and a second lower strap coupling end 416B. The second lower strap mounting end 414B may be coupled to the second lateral region 384B of the lower region 354 of the flexible panel 352. The second lower coupler 358B may further include a second lower latch 418B operatively attached to the second lower strap coupling end 416B. In the example shown in FIGS. 13A through 14, the first lower latch 418A and/or the second lower latch 418B may be configured as clamps 430 configured to engage the shoulder straps 424 to couple the flexible panel 352 to the lower support assembly 108.

The first lower strap 412A and the second lower strap 412B may be comprised of any suitable material. For example, the first lower strap 412A and/or the second lower strap 412B may be comprised of a fabric that is coated, similar to the flexible panel 352, described above. It is also contemplated that the first lower strap 412A and the second lower strap 412B may be formed of nylon webbing, polypropylene webbing, cotton webbing, elastic webbing, and the like. The first lower strap mounting end 414A of the first lower strap 412A and the second lower strap mounting end 414B of the second lower strap 412B may be operatively attached to the flexible panel 352 in any suitable manner. For example, the first lower strap mounting end 414A of the first lower strap 412A and the second lower strap mounting end 414B of the second lower strap 412B may be stitched to the flexible panel 352 using a stitching pattern such as a box X stitch, double W stitch, diamond stitch, horizontal diamond stitch, the like, or a combination thereof. As another example, the first lower strap mounting end 414A of the first lower strap 412A and the second lower strap mounting end 414B of the second lower strap 412B may be integrally formed as a unitary component with the flexible panel 352.

FIGS. 13A through 14 show another example of the head brace 350. FIG. 10A shows the rear face 368, while FIG. 10B shows the front face 366. FIG. 11B shows the head brace 350 of FIGS. 10A and 10B coupled to the handle assembly 132 and the rear support assembly 108 of the patient transport system 100. In this example, the catch 382 of the upper coupler 360 may include a catch panel 432. The catch panel 432 may be coupled to one of the front face 366 and the rear face 368 of the flexible panel 352. The catch panel 342 may define a catch void 434. As described above, the upper coupler 360 may include a latch strap 374 supporting a latch 380, and the latch strap 374 may loop around the handle assembly 132. Accordingly, the catch void 434 may be configured to receive the latch 380 to couple the flexible panel 352 to the handle assembly 132. The catch void 434 may define a first catch slot 436A and a second catch slot 436B spaced from the first catch slot 436A. The first catch slot 436A and the second catch slot 436B may define a catch land 438 therebetween. In some examples, stitching may surround the catch void 434 to reinforce the catch void 434.

As best shown in FIG. 14, the latch 380 may define a latch projection 440. The latch projection 440 may be shaped to removably extend through the first catch slot 436A and the second catch slot 436B and abut the catch land 438 to couple the latch 380 to the catch 382, thereby coupling the flexible panel 352 to the handle assembly 132.

As described above, the upper coupler 360 may be defined as a first upper coupler 360A operatively attached to the first lateral region 384A of the upper region 356 of the flexible panel 352, and the head brace 350 may include the second upper coupler 360B operatively attached to the second lateral region 384B of the upper region 356 of the flexible panel 352. Accordingly, the latch strap 374 may be defined as a first latch strap 374A, the latch 380 may be defined as a first latch 380A defining a first latch projection 440A, the catch 382 may be defined as a first catch 382A, and the catch void 434 may be defined as a first catch void 434A. The second upper coupler 360B may further include a second catch void 434B defined by the catch panel 432, the second latch strap 374B, and the second latch 380B. Similarly, the second catch void 434B may define a first catch slot 436A and a second catch slot 436B spaced from the first catch slot 436A. The first catch slot 436A and the second catch slot 436B may define a catch land 438 therebetween. Additionally, the second latch 380B may define a second latch projection 440B, the second latch projection 440B shaped to removably extend through the first catch slot 436A and the second catch slot 436B of the second catch void 434B and abut the catch land 438 to couple the second latch 380B to the second catch 382B, thereby coupling the flexible panel 352 to the handle assembly 132.

Each of the first latch projection 440A and the second latch projection 440B may define a J-shaped profile 442. The J-shaped profile 442 is configured to engage the catch land 438 of the first catch 382A and the second catch 382B, respectively, to inhibit the first latch 380A from being disengaged from the first catch 382A and inhibit the second latch 380B from being disengaged from the second catch 382B. In other words, each of the first latch projection 440A and the second latch projection 440B may define a contact face 444 disposed in abutment with the catch land 438 of the first catch 382A and the second catch 382B, respectively, and a stop face 446 arranged adjacent to the contact face 444 to inhibit the first latch 380A from being disengaged from the first catch 382A and inhibit the second latch 380B from being disengaged from the second catch 382B.

As best shown in FIG. 13A, in some examples, the first latch strap 374A and/or the second latch strap 374B may be integrally formed with the catch panel 432 as a unitary component. Additionally, the flexible panel 352 may include an upper hem 448. The upper hem 448 may be folded over the catch panel 432. Flexible panel 352 may include stitches disposed around a periphery of the upper hem 448 and through the catch panel 432 and flexible panel 352 to couple the catch panel 432 to the flexible panel 352. Similarly, the catch panel 432 may include stitches disposed around a periphery of the catch panel 432 and through the catch panel 432 and flexible panel 352 to couple the catch panel 432 to the flexible panel 352.

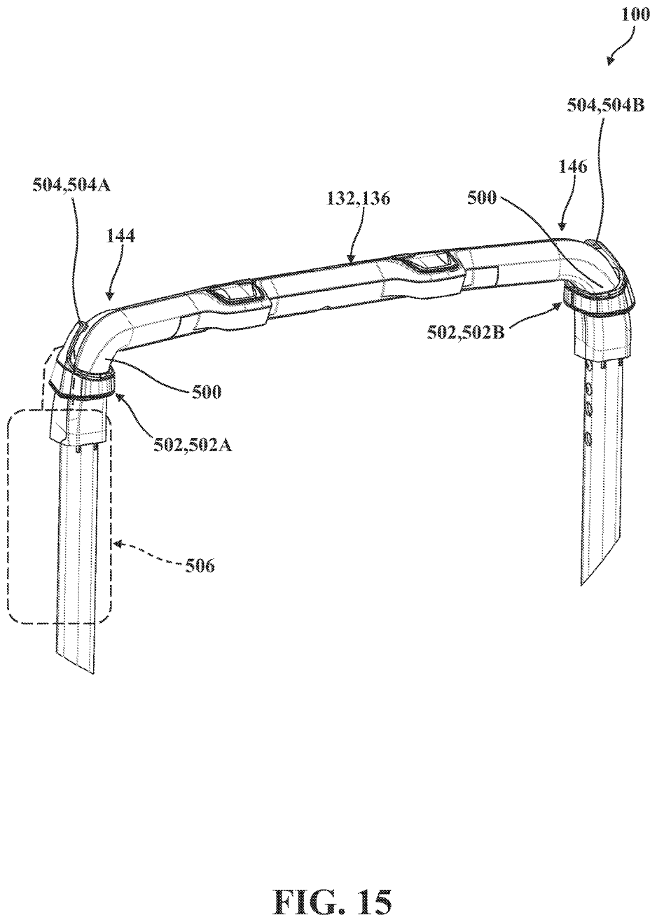

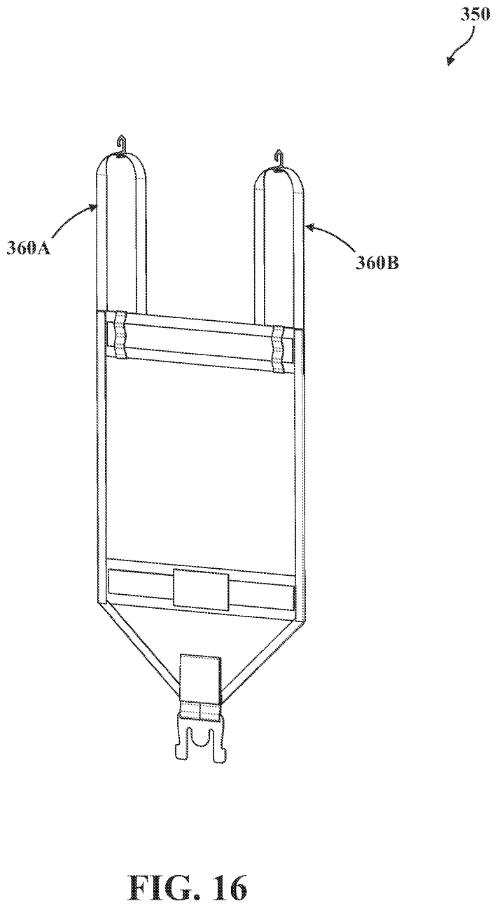

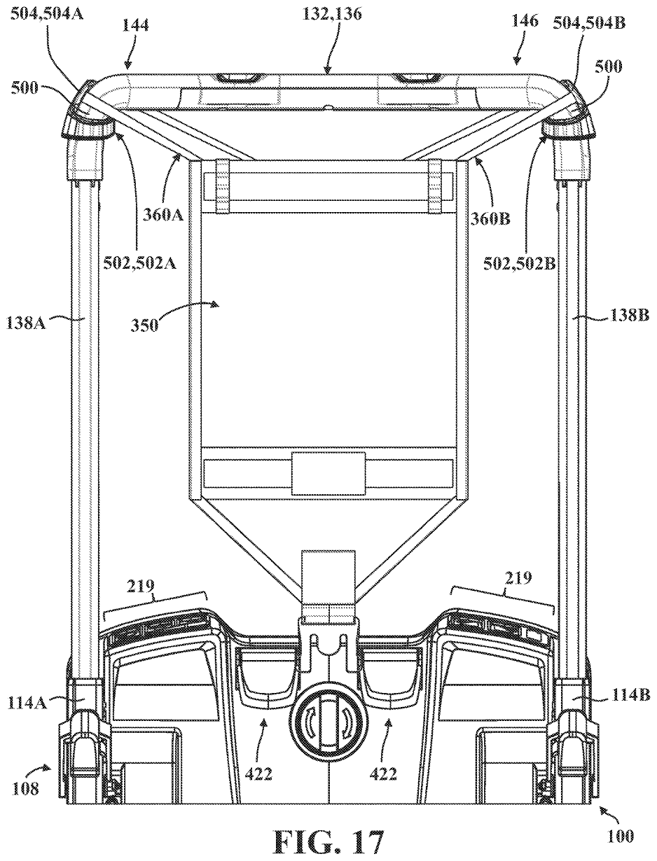

Referring now to FIGS. 15-20D, as noted above, another version of the head brace 350 is shown in FIGS. 16-17. For the purposes of clarity, consistency, and brevity, the description of other versions of the head brace 350 (e.g., the version depicted in FIG. 11) also apply to this version of the head brace 350 unless otherwise indicated.

In this version, the upper grip 136 of the handle assembly 132 defines an outer handle surface 500 adjacent to each of the first and second hand grip regions 144, 146 which supports first and second hook assemblies 502A, 502B as described in greater detail below. The first hook assembly 502A is operatively attached to the handle assembly 132 adjacent to the first grip region 144, and the second hook assembly 502B is operatively attached to the handle assembly 132 adjacent to the second grip region 146. The hook assemblies 502A, 502B each define a respective hook 504A, 504B which, in the version depicted in FIG. 17, may be arranged to support the first and second upper couplers 360A, 360B. Here, the first upper coupler 360A is routed by the first hook 504A, and the second upper coupler 360B is routed by the second hook 504B to retain the head brace 350 to the handle assembly 132. While the illustrated version employs the first and second hook assemblies 502A, 502B to secure versions of the head brace 350, it will be appreciated that the patient transport system 100 could employ other versions of the head brace 350 that do not necessarily engage the first and second hook assemblies 502A, 502B (e.g., as described above in connection with FIG. 11). For example, in some versions, one or more hook assemblies 502 could be employed to facilitate retaining an equipment module 506 (see FIG. 15; depicted generically) to the patient transport system 100. Put differently, the hook 504 of the hook assembly 502 could be used to support equipment modules 506 of various types, styles, and arrangements. In some versions, the equipment module 506 could be realized as an intravenous fluid bag. In some versions, the equipment module 506 could be realized as a personal belongings holder (e.g., a plastic bag), a trauma kit, a coat or jacket, and the like. Other configurations are contemplated, and it will be appreciated that versions which employ the first and second hook assemblies 502A, 502B to retain the head brace 350 could also simultaneously support the equipment module 506 (not shown in detail).

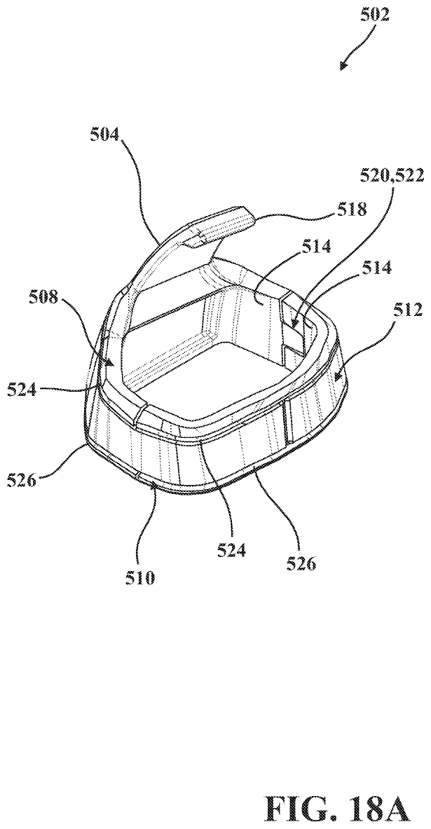

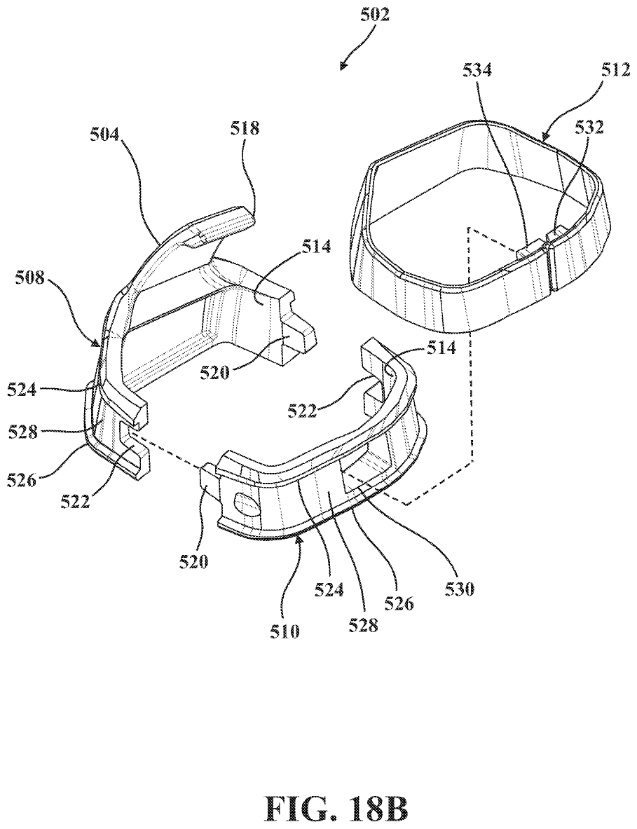

As is best depicted in FIGS. 18A-20D, the hook assembly 502 generally includes a brace body 508, a collar body 510, and a clip 512. The brace body 508 defines the hook 504 and is shaped to releasably engage the collar body 510. The clip 512 retains the collar body 510 in engagement with the brace body 508 to operatively attach the hook assembly 502 to the handle assembly 132, as described in greater detail below. The brace body 508 and the collar body 510 each at least partially define an inner support surface 514 which is disposed in engagement with the outer handle surface 500 of the handle assembly 132. Here, the outer handle surface 500 and the inner support surface 514 of the hook assembly 502 are each tapered to define a dovetail 516 to operatively attach the hook assembly 502 to the handle assembly 132. The dovetail 516 creates a “friction lock” which securely retains the hook assembly 502 to the handle assembly 132, and the arrangement of the tapered profiles afford increased retention as weight, load, and the like is applied to the hook assembly 502.

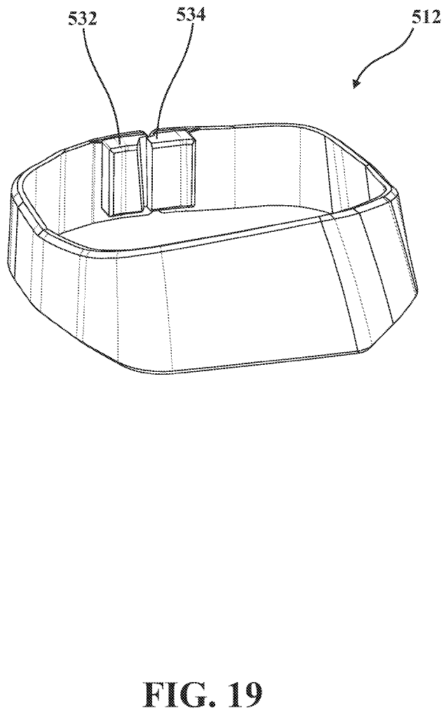

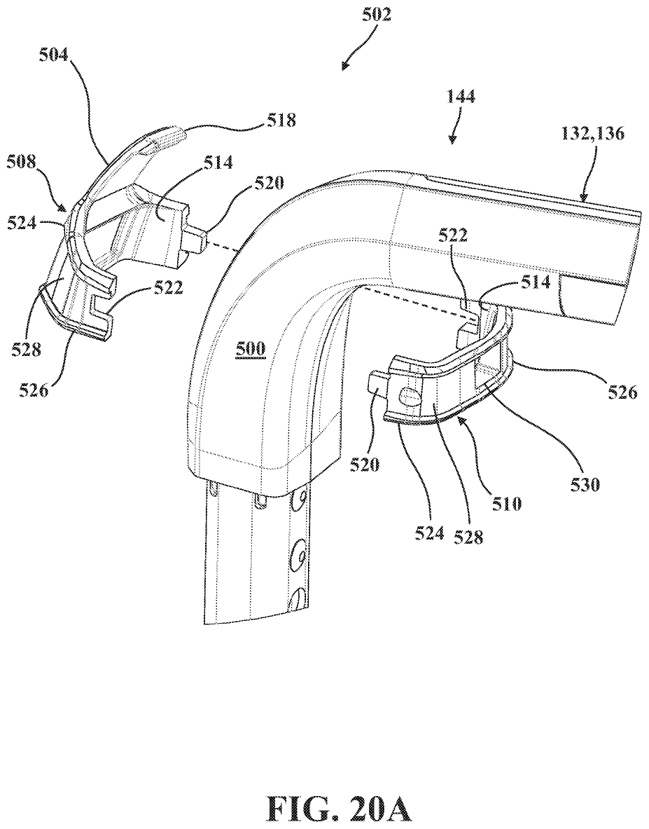

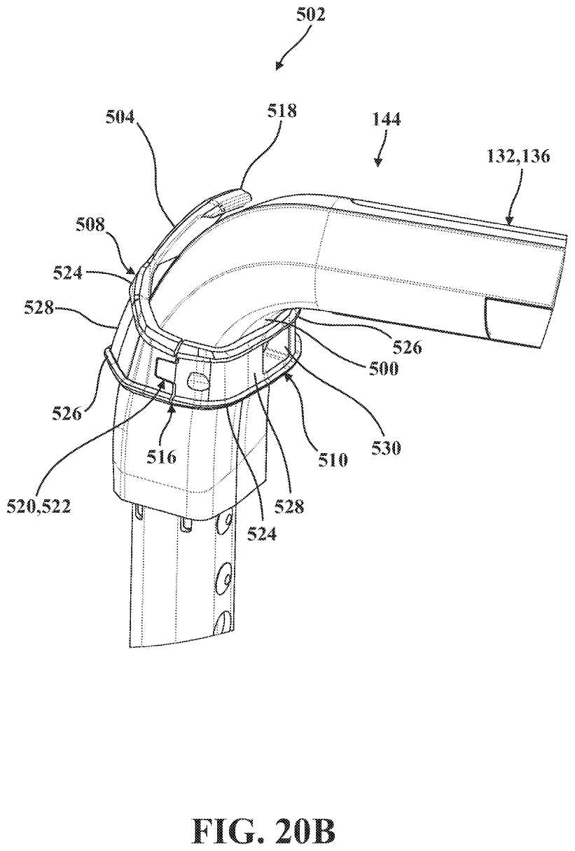

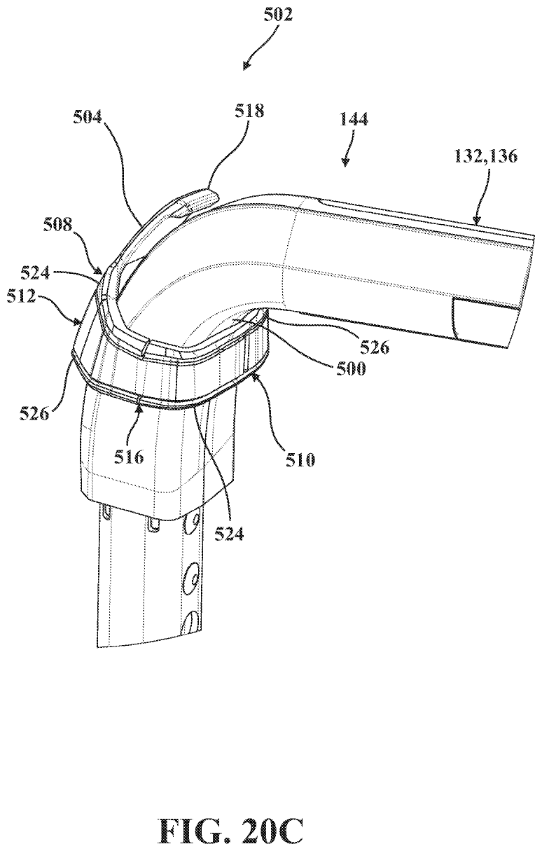

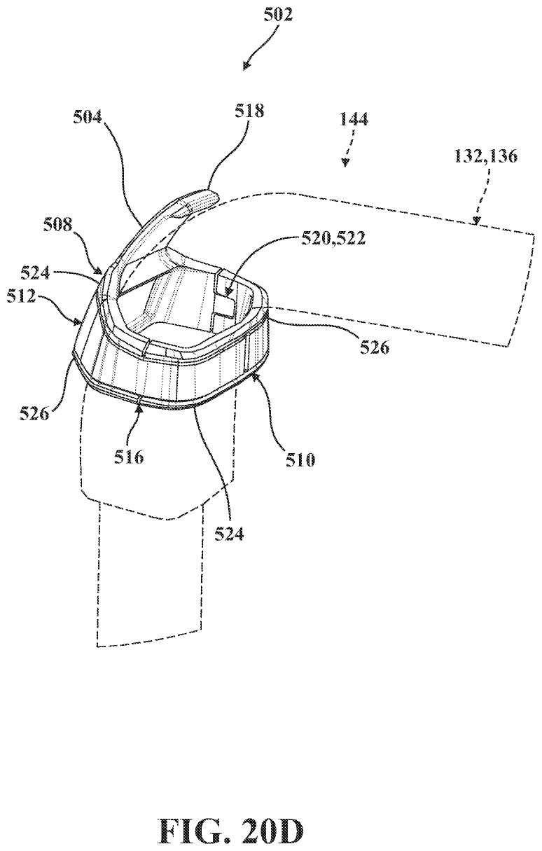

The brace body 508 and the collar body 510 each have a generally C-shaped profile defining at least a portion of the inner support surface 514 with a tapered profile that is complimentary to respective portions of the outer handle surface 500. The brace body 508 defines the hook 504 as noted above, which extends to a finger 518 with a profile which is complimentary to the shape of the adjacent portions of the handle assembly 132 (see FIG. 17). This configuration places the hook 504 in close proximity to the handle assembly 132 without negatively impacting the ability of the user to engage the grip regions 144, 146 and while affording the ability to quickly and efficiently utilize the hook 504 to secure the head brace 350, the equipment module 506, and the like. The brace body 508 and the collar body 510 each define a respective tooth 520 and a socket 520 shaped to receive the tooth 520 to facilitate initial positioning and retention of the brace body 508 and the collar body 510 to the handle assembly 132 prior to attachment of the clip 512 (see FIGS. 20A-20D). The brace body 508 and the collar body 510 also each include respective upper and lower lips 524, 526 which are arranged adjacent to seats 528 shaped to receive the clip 512. The collar body 510 also includes a window 530 defined extending through a portion of the seat 528, which is shaped to releasably receive first and second tabs 532, 534 of the clip 512. In the illustrated version, the clip 512 has a tapered profile which is shaped complimentary to the seats 528 of the brace body 508 and the collar body 510, and has a “split” configuration to facilitate routing into the seats 528 to retain the brace body 508 and the collar body 510 together. To this end, the collar is formed from a resilient material (e.g., various types of plastic, metal, and the like which can be at least partially deflected without permanently deforming), and the first and second tabs 532, 534 are shaped so as to “interlock” with the second tab 534 overhanging a portion of the first tab 532 (see FIG. 19) within the window 530. It will be appreciated that this configuration allows the hook assembly 502 to be installed in a simple manner without requiring special tools while, at the same time, affording strong retention to the handle assembly 132.

Several configurations have been discussed in the foregoing description. However, the configurations discussed herein are not intended to be exhaustive or limit the invention to any particular form. The terminology which has been used is intended to be in the nature of words of description rather than of limitation. Many modifications and variations are possible in light of the above teachings and the invention may be practiced otherwise than as specifically described.

The present disclosure also comprises the following clauses, with specific features laid out in dependent clauses, that may specifically be implemented as described in greater detail with reference to the configurations and drawings above.

### CLAUSES

I. A patient transport system comprising:
a support structure including rear support assembly;
a seat section and a back section coupled to the support structure and defining a support surface for supporting a patient;
a track assembly extending from the support structure and having a belt for traversing stairs;
a handle assembly operatively attached to the rear support assembly and configured for movement between a collapsed position and an extended position;
a motor coupled to the track assembly to selectively generate torque to drive the belt;
a user interface including an activation input control disposed on the handle assembly and arranged for engagement by a user for operating the motor to drive the belt; and
a head brace comprising:
   a flexible panel extending between a lower region and an upper region;
   a lower coupler operatively attached to the lower region and releasably attached to the rear support assembly; and
   an upper coupler operatively attached to the upper region and releasably attached to the handle assembly;
wherein movement of the handle assembly to the extended position places tension in the flexible panel to define a head support surface for the patient.

II. The patient transport system of clause I, wherein the flexible panel is disposed out of tension
when the handle assembly is spaced from the extended position such that the flexible panel is flaccid.

III. The patient transport system of clause II, wherein the flaccid flexible panel defines a fold in response to movement of the handle assembly toward the collapsed position.

IV. The patient transport system of any of clauses I-III, wherein:
the user interface further includes at least one lower input control disposed on the rear support assembly; and
the flexible panel defines a tapered profile that narrows from the upper region to the lower region to define an access region to permit the user to engage the at least one lower input control.

V. The patient transport system of clause IV, wherein the head brace further comprises a lower webbing disposed above the tapered profile and coupled to the flexible panel.

VI. The patient transport system of clause V, wherein the flexible panel includes a peripheral hem extending around a periphery of the flexible panel and folded over the lower webbing.

VII. The patient transport system of clause VI, wherein the flexible panel includes peripheral stitches disposed through the peripheral hem, the lower webbing, and the flexible panel.

VIII. The patient transport system of any of clauses IV-VII wherein:
the flexible panel defines a fold in response to movement of the handle assembly toward the collapsed position;
the user interface further includes at least one lower input control disposed on the rear support assembly; and
the tapered profile and the fold cooperate to define the access region to permit a user to engage the at least one lower input control when the handle assembly is arranged toward the collapsed position.

IX. The patient transport system of any of clauses I-VIII, wherein the flexible panel further comprises:
a front face defining the head support surface and configured to face away from the track assembly when the flexible panel is disposed in tension with the handle assembly in the extended position; and
a rear face, opposite the front face, configured to face the track assembly when the flexible panel is disposed in tension with the handle assembly in the extended position.

X. The patient transport system of clause IX, wherein the upper coupler further comprises:
a latch strap extending between:
   a latch strap mounting end operatively attached to one of the front face and the rear face of the flexible panel at the upper region, and
   a latch strap coupling end;
a latch operatively attached to the latch strap coupling end; and
a catch operatively attached to the other of the front face and the rear face of the flexible panel at the upper region;
wherein the latch strap is configured to loop around the handle assembly and the latch is configured to engage the catch to couple the flexible panel to the handle assembly.

XI. The patient transport system of clause X, wherein:
the upper region of the flexible panel includes a coupling flap folded over the latch strap to define a latch strap coupling loop; and
the latch strap extends through the latch strap coupling loop and is stitched to the coupling flap to couple the latch strap to the flexible panel.

XII. The patient transport system of any of clauses X-XI, wherein the latch strap includes a first lateral portion and a second lateral portion separate from the first lateral portion, with a gap defined therebetween to receive the activation input control such that the first lateral portion and the second lateral portion of the latch strap straddle the activation input control to inhibit lateral movement of the latch strap along the handle assembly.

XIII. The patient transport system of any of clauses X-XIII, wherein the upper coupler further comprises a catch strap extending between:
a catch strap mounting end operatively attached to the other of the front face and the rear face of the flexible panel at the upper region; and
a catch strap coupling end supporting the catch.

XIV. The patient transport system of clause XIII, wherein the head brace further comprises an upper webbing disposed over the catch strap and coupled to the flexible panel.

XV. The patient transport system of clause XIV, wherein the flexible panel includes a peripheral hem extending around a periphery of the flexible panel and folded over the upper webbing.

XVI. The patient transport system of clause XV, wherein the flexible panel includes peripheral stitches disposed through the peripheral hem, the upper webbing, and the flexible panel.

XVII. The patient transport system of any of clauses XIV-XVI, wherein the head brace further comprises a lower webbing coupled to the flexible panel and spaced below the upper webbing.

XVIII. The patient transport system of clause XVII, wherein the flexible panel includes a peripheral hem extending around a periphery of the flexible panel and folded over the upper webbing and the lower webbing.

XIX. The patient transport system of any of clauses X-XVIII, wherein the catch comprises a catch panel operatively attached to one of the front face and the rear face of the flexible panel at the upper region, the catch panel defining a catch void configured to receive the latch to couple the flexible panel to the handle assembly.

XX. The patient transport system of clause XIX, wherein:
the catch void is further defined as a first catch slot and a second catch slot spaced from the first catch slot, thereby defining a catch land therebetween; and
the latch defines a latch projection shaped to removably extend through the first and second catch slots and abut the catch land to couple the flexible panel to the handle assembly.

XXI. The patient transport system of clause XX, wherein the latch projection defines a J-shaped profile configured to engage the catch land to inhibit the latch from being disengaged from the catch.

XXII. The patient transport system of clause XXI, wherein latch projection defines a contact face disposed in abutment with the catch land, and a stop face arranged adjacent to the contact face to inhibit the latch from being disengaged from the catch.

XXIII. The patient transport system of any of clauses XXI-XXII, wherein the latch strap is integral with the catch panel.

XXIV. The patient transport system of any of clauses I-XXIII, wherein:
the upper coupler is further defined as a first upper coupler operatively attached to a first lateral region of the upper region; and
the head brace further includes a second upper coupler operatively attached to a second lateral region of the upper region, opposite the second lateral region.

XXV. The patient transport system of clause XXIV, wherein the flexible panel further comprises:
a front face defining the head support surface and configured to face away from the track assembly when the flexible panel is disposed in tension with the handle assembly in the extended position; and
a rear face, opposite the front face, configured to face the track assembly when the flexible panel is disposed in tension with the handle assembly in the extended position.

XXVI. The patient transport system of clause XXV, wherein:
the first upper coupler further comprises:
   a first latch strap extending between:
      a first latch strap mounting end operatively attached to one of the front face and the rear face of the flexible panel at the first lateral region of the upper region, and
      a first latch strap coupling end;
   a first latch operatively attached to the first latch strap coupling end; and
   a first catch operatively attached to the other of the front face and the rear face of the flexible panel at the first lateral region of the upper region; and
the second upper coupler further comprises:
   a second latch strap extending between:
      a second latch strap mounting end operatively attached to one of the front face and the rear face of the flexible panel at the second lateral region of the upper region, and
      a second latch strap coupling end;
   a second latch operatively attached to the second latch strap coupling end; and
   a second catch operatively attached to the other of the front face and the rear face of the flexible panel at the second lateral region of the upper region; and
   wherein the first and second latch straps are configured to loop around the handle assembly and the first and second latches are configured to engage the first and second catches, respectively, to couple the flexible panel to the handle assembly.

XXVII. The patient transport system of clause XXVI, wherein:
the handle assembly includes an upper grip defining a first hand grip region and a second hand grip region;
the activation input control is further defined as a first activation input control disposed adjacent to the first hand grip region;
the user interface further includes a second activation input control disposed adjacent to the second hand grip region;
each of the first latch strap and the second latch strap define a first lateral portion, a second lateral portion separate from the first lateral portion, and a gap therebetween; and
the gap of the first latch strap is configured to receive the first activation input control such that the first lateral portion and the second lateral portion of the first latch strap abut the first activation input control to inhibit lateral movement of the first latch strap along the handle assembly; and
the gap of the second latch strap is configured to receive the second activation input control such that the first lateral portion and the second lateral portion of the second latch strap abut the second activation input control to inhibit lateral movement of the second latch strap along the handle assembly.

XXVIII. The patient transport system of any of clauses XXVI-XXVII, wherein:
the first upper coupler further comprises a first catch strap extending between:
   a first catch strap mounting end operatively attached to the other of the front face and the rear face of the flexible panel at the first lateral region of the upper region; and
   a first catch strap coupling end supporting the first catch; and
the second upper coupler further comprises a second catch strap extending between:
   a second catch strap mounting end operatively attached to the other of the front face and the rear face of the flexible panel at the second lateral region of the upper region; and
   a second catch strap coupling end supporting the second catch.

XXIX. The patient transport system of clause XXVIII, wherein head brace further comprises a catch panel operatively attached to the other of the front face and the rear face of the flexible panel at the upper region, the catch panel defining:
a first catch void arranged at the first lateral region of the upper region, and
a second catch void arranged at the second lateral region of the upper region;
   wherein the first and second catch void are configured to receive the first and second latches, respectively, to couple the flexible panel to the handle assembly.

XXX. The patient transport system of clause XXIX, wherein the first latch strap and the second latch strap are integral with the catch panel.

XXXI. The patient transport system of clause XXX, wherein the catch panel includes a first face and a second face, opposite the first face, and the first face of the catch panel faces the rear face of the flexible panel.

XXXII. The patient transport system of clause XXXI, wherein the upper region of the flexible panel includes an upper hem folded over the catch panel.

XXXIII. The patient transport system of clause XXXII, wherein stitches are disposed around a periphery of the upper hem and through the catch panel and flexible panel to couple the catch panel to the flexible panel.

XXXIV. The patient transport system of any of clauses I-XXXIII, wherein the lower coupler further comprises a lower latch strap extending between:
a lower strap mounting end coupled to the lower region of the flexible panel; and
a lower strap coupling end.

XXXV. The patient transport system of clause XXXIV, wherein the lower strap mounting end is coupled to the flexible panel with a box stitch disposed through the lower strap mounting end and the flexible panel.

XXXVI. The patient transport system of any of clauses XXXIV-XXXV, wherein the lower coupler further comprises a lower latch operatively attached to the lower strap coupling end.

XXXVII. The patient transport system of clause XXXVI, wherein the rear support assembly further comprises a lower catch, and the lower latch is configured to engage the lower catch to couple the flexible panel to the rear support assembly.

XXXVIII. The patient transport system of clause XXXVII, wherein the lower catch is defined by a pair of shoulder strap harnesses disposed on the rear support assembly, each shoulder strap harness defining a lower catch void configured to receive the lower latch.

XXXIX. The patient transport system of clause XXXVIII, wherein the lower latch defines opposing deflectable prongs each including a lower latch projection, and each lower latch projection is respectively configured to engage the lower catch void to couple the flexible panel to the rear support assembly.

XL. The patient transport system of any of clauses XX) XVI-XXXIX, wherein the rear support assembly further comprises a shoulder strap, and the lower latch is configured to engage the shoulder strap to couple the flexible panel to the rear support assembly.

XLI. The patient transport system of any of clauses I-XL, wherein the lower coupler further comprises a lower latch operatively attached to the flexible panel and defining opposing deflectable prongs each releasably engageable with lower catch voids defined by the rear support assembly.

XLII. The patient transport system of any of clauses I-XLI, further comprising a hook assembly operatively attached to the handle assembly, the hook assembly defining a hook; and
wherein the upper coupler of the head brace is routed by the hook of the hook assembly to retain the head brace to the handle assembly.

XLIII. The patient transport system of clause XLII, wherein the handle assembly defines a grip region arranged for user engagement; and
wherein the hook assembly is operatively attached to the handle assembly adjacent to the grip region.

XLIV. The patient transport system of clause XLIII, wherein the handle assembly defines an outer handle surface adjacent to the grip region; and
wherein the hook assembly defines an inner support surface disposed in engagement with the outer handle surface.

XLV. The patient transport system of clause XLIV, wherein the outer handle surface and the inner support surface are each tapered to define a dovetail to operatively attach the hook assembly to the handle assembly.

XLVI. The patient transport system of any of clauses XLIV-XLV, wherein the hook assembly includes a brace body defining the hook, and a collar body shaped to releasably engage the brace body, with the brace body and the collar body each at least partially defining the inner support surface.

XLVII. The patient transport system of clause XLVI, wherein the hook assembly further includes a clip to retain the collar body in engagement with the brace body to operatively attach the hook assembly to the handle assembly.

XLVIII. The patient transport system of any of clauses I-XLVII, further comprising a hook assembly operatively attached to the handle assembly, the hook assembly defining a hook to support an equipment module relative to the handle assembly.

XLIX. The patient transport system of clause XLVIII, wherein the equipment module is further defined as an intravenous fluid bag.

L. The patient transport system of any of clauses I-XLIX, further comprising a first and second hook assemblies operatively attached to the handle assembly and defining respective first and second hooks;
wherein the upper coupler is further defined as a first upper coupler and the head brace further includes a second upper coupler operatively attached to the upper region and spaced laterally from the first upper coupler; and
wherein the first upper coupler is routed by the first hook and the second upper coupler is routed by the second hook to retain the head brace to the handle assembly.

LI. The patient transport system of clause L, wherein the handle assembly includes an upper grip defining a first hand grip region and a second hand grip region spaced laterally from the first hand grip region; and
wherein the first hook assembly is operatively attached to the handle assembly adjacent to the first hand grip region, and the second hook assembly is operatively attached to the handle assembly adjacent to the second hand grip region.

1. A patient transport system comprising:
a support structure including rear support assembly;
a seat section and a back section coupled to the support structure and defining a support surface for supporting a patient;
a track assembly extending from the support structure and having a belt for traversing stairs;
a handle assembly operatively attached to the rear support assembly and configured for movement between a collapsed position and an extended position;
a motor coupled to the track assembly to selectively generate torque to drive the belt;
a user interface including an activation input control disposed on the handle assembly and arranged for engagement by a user for operating the motor to drive the belt; and
a head brace comprising:
a flexible panel extending between a lower region and an upper region;
a lower coupler operatively attached to the lower region and releasably attached to the rear support assembly; and
an upper coupler operatively attached to the upper region and releasably attached to the handle assembly;
wherein movement of the handle assembly to the extended position places tension in the flexible panel to define a head support surface for the patient.

2. The patient transport system of claim 1, wherein the flexible panel is disposed out of tension when the handle assembly is spaced from the extended position such that the flexible panel is flaccid.

3. The patient transport system of claim 2, wherein the flaccid flexible panel defines a fold in response to movement of the handle assembly toward the collapsed position.

4. The patient transport system of claim 1, wherein:
the user interface further includes at least one lower input control disposed on the rear support assembly; and
the flexible panel defines a tapered profile that narrows from the upper region to the lower region to define an access region to permit the user to engage the at least one lower input control.

5. The patient transport system of claim 4, wherein the head brace further comprises a lower webbing disposed above the tapered profile and coupled to the flexible panel.

6. The patient transport system of claim 5, wherein the flexible panel includes a peripheral hem extending around a periphery of the flexible panel and folded over the lower webbing.

7. (canceled)

8. The patient transport system of claim 4, wherein:
the flexible panel defines a fold in response to movement of the handle assembly toward the collapsed position;
the user interface further includes at least one lower input control disposed on the rear support assembly; and
the tapered profile and the fold cooperate to define the access region to permit a user to engage the at least one lower input control when the handle assembly is arranged toward the collapsed position.

9. The patient transport system of claim 1, wherein the flexible panel further comprises:
a front face defining the head support surface and configured to face away from the track assembly when the flexible panel is disposed in tension with the handle assembly in the extended position; and
a rear face, opposite the front face, configured to face the track assembly when the flexible panel is disposed in tension with the handle assembly in the extended position.

10. The patient transport system of claim 9, wherein the upper coupler further comprises:
a latch strap extending between:
a latch strap mounting end operatively attached to one of the front face and the rear face of the flexible panel at the upper region, and
a latch strap coupling end;
a latch operatively attached to the latch strap coupling end; and
a catch operatively attached to the other of the front face and the rear face of the flexible panel at the upper region;
wherein the latch strap is configured to loop around the handle assembly and the latch is configured to engage the catch to couple the flexible panel to the handle assembly.

11. The patient transport system of claim 10, wherein:
the upper region of the flexible panel includes a coupling flap folded over the latch strap to define a latch strap coupling loop; and
the latch strap extends through the latch strap coupling loop and is stitched to the coupling flap to couple the latch strap to the flexible panel.

12. The patient transport system of claim 10, wherein the latch strap includes a first lateral portion and a second lateral portion separate from the first lateral portion, with a gap defined therebetween to receive the activation input control such that the first lateral portion and the second lateral portion of the latch strap straddle the activation input control to inhibit lateral movement of the latch strap along the handle assembly.

13. The patient transport system of claim 10, wherein the upper coupler further comprises a catch strap extending between:
a catch strap mounting end operatively attached to the other of the front face and the rear face of the flexible panel at the upper region; and
a catch strap coupling end supporting the catch.

14. The patient transport system of claim 13, wherein the head brace further comprises an upper webbing disposed over the catch strap and coupled to the flexible panel.

15. The patient transport system of claim 14, wherein the flexible panel includes a peripheral hem extending around a periphery of the flexible panel and folded over the upper webbing.

16. The patient transport system of claim 15, wherein the flexible panel includes peripheral stitches disposed through the peripheral hem, the upper webbing, and the flexible panel.

17. The patient transport system of claim 14, wherein the head brace further comprises a lower webbing coupled to the flexible panel and spaced below the upper webbing.

18. The patient transport system of claim 17, wherein the flexible panel includes a peripheral hem extending around a periphery of the flexible panel and folded over the upper webbing and the lower webbing.

19. The patient transport system of claim 10, wherein the catch comprises a catch panel operatively attached to one of the front face and the rear face of the flexible panel at the upper region, the catch panel defining a catch void configured to receive the latch to couple the flexible panel to the handle assembly.

20. The patient transport system of claim 19, wherein:
the catch void is further defined as a first catch slot and a second catch slot spaced from the first catch slot, thereby defining a catch land therebetween; and
the latch defines a latch projection shaped to removably extend through the first and second catch slots and abut the catch land to couple the flexible panel to the handle assembly.

21. (canceled)

22. (canceled)

23. (canceled)

24. (canceled)

25. (canceled)

26. (canceled)

27. (canceled)

28. (canceled)

29. (canceled)

30. (canceled)

31. (canceled)

32. (canceled)

33. (canceled)

34. (canceled)

35. (canceled)

36. (canceled)

37. (canceled)

38. (canceled)

39. (canceled)

40. (canceled)

41. (canceled)

42. (canceled)

43. (canceled)

44. (canceled)

45. (canceled)

46. (canceled)

47. (canceled)

48. The patient transport system of claim 1, further comprising a hook assembly operatively attached to the handle assembly, the hook assembly defining a hook to support an equipment module relative to the handle assembly.

49. (canceled)

50. (canceled)

51. (canceled)
